(19) United States
(12) Patent Application Publication
(10) Pub. No.: US 2023/0085778 A1
(43) Pub. Date: Mar. 23, 2023

(54) LITHIUM ION CELLS WITH HIGH RATE ELECTROLYTE FOR CELLS WITH SILICON OXIDE ACTIVE MATERIALS ACHIEVING LONG CYCLE LIFE

(71) Applicant: Zenlabs Energy, Inc., Fremont, CA (US)

(72) Inventors: Kevin Hays, Fremont, CA (US); Ayyappan Elangovan, Fremont, CA (US); Sujeet Kumar, Newark, CA (US); Herman A. Lopez, Sunnyvale, CA (US)

(21) Appl. No.: 17/940,700

(22) Filed: Sep. 8, 2022

Related U.S. Application Data
(60) Provisional application No. 63/242,732, filed on Sep. 10, 2021.

(51) Int. Cl. H01M 10/0568; H01M 10/0569; H01M 10/0567; H01M 10/0525; H01M 4/62; H01M 4/38; H01M 4/485; H01M 50/46

(52) U.S. Cl. CPC H01M 10/0568; H01M 10/0569; H01M 10/0567; H01M 10/0525; H01M 4/622; H01M 4/386; H01M 4/625; H01M 4/485; H01M 50/46; H01M 2004/027

(57) ABSTRACT

Electrolytes are described that involve lithium salt blends and compatible nonaqueous solvents that provide to high rate performance, charging and discharging, of lithium ion cells using silicon-based active materials, such as silicon suboxide composites, for example, silicon oxide/silicon/carbon composites. The lithium salts generally were a blend of LiPF₆, and LiFSI or LiTFSI. The solvents generally comprised fluoroethylene carbonate and dimethyl carbonate with optional cosolvents and/or other additives.

### CROSS REFERENCE TO RELATED APPLICATIONS

This application claims priority to co-pending U.S. provisional patent application 63/242,732 filed Sep. 10, 2021 to Hays et al., entitled Lithium Ion Cells With High Rate Electrolyte for Cells With Silicon Oxide Active Materials Achieving Long Cycle Life,” incorporated herein by reference.

### FIELD OF THE INVENTION

The invention relates to lithium ion cells comprising silicon oxide active materials having very high power capability along with high energy density with good cycling. The invention also relates to electrolytes facilitate these performance achievements.

### BACKGROUND OF THE INVENTION

Lithium batteries are widely used in consumer electronics due to their relatively high energy density. For some current commercial batteries, the negative electrode material can be graphite, and the positive electrode materials can comprise lithium cobalt oxide (LiCoO₂), lithium manganese oxide (LiMₙ_{₂}O₄), lithium iron phosphate (LiFePO₄), lithium nickel oxide (LiNiO₂), lithium nickel cobalt oxide (LiNiCoO₂), lithium nickel cobalt manganese oxide (LiNiMnCoO₂), lithium nickel cobalt aluminum oxide (LiNiCoAlO₂) and the like. For negative electrodes, lithium titanate is an alternative to graphite with good cycling properties, but it has a lower energy density. Other alternatives to graphite, such as tin oxide and silicon, have the potential for providing increased energy density. However, some high capacity negative electrode materials have been found to be unsuitable commercially due to high irreversible capacity loss and poor discharge and recharge cycling related to structural changes and anomalously large volume expansions, especially for silicon, that are associated with lithium intercalation/alloying. The structural changes and large volume changes can destroy the structural integrity of the electrode, thereby decreasing the cycling efficiency.

### SUMMARY OF THE INVENTION

In a first aspect, the invention pertains to a high rate capable electrolyte for a lithium-based cell consisting of:

about 1.3M to about 2.5M lithium salt, consisting of from about 0.05M to about 0.8M LiPF₆, from about 0.8M to about 2.1M lithium bis(fluorosulfonyl)imide (LiFSI) or lithium bis(trifluoromethanesulfonyl)imide (LiTFSI), and no more than about 5 mole percent optional other lithium salts;

from about 5 weight percent (wt %) to about 25 wt % fluoroethylene carbonate;

from about 65 wt % to about 95 wt % cosolvent consisting of at least about 30 wt % dimethyl carbonate, from 0 to about 50 wt % diethyl carbonate, from 0 to about 50 wt % hydrofluoro ether, from about 0 to about 50 wt % fluorinated linear carbonate, from about 0 to about 20 wt % propylene carbonate, from about 0 to about 20 wt % alkyl acetate, and mixtures thereof, wherein the weight percent values of fluoroethylene carbonate and cosolvent add to 100 wt %; and no more than about 10 weight percent optional additives relative to the total electrolyte weight.

In a further aspect, the invention pertains to a lithium ion cell comprising a negative electrode, a positive electrode, a separator between the negative electrode and the positive electrode, electrolyte and a container enclosing the negative electrode, the positive electrode, the separator and the electrolyte. The negative electrode can comprise from about 75 wt % to about 96 wt % an active material, from about 0.1 wt % to about 7 wt % nanoscale conductive particulates and from about 4 wt % to about 20 wt % polymer binder, wherein the active material comprises from about 45 wt % to about 100% silicon-based active material, and from 0 wt % to about 55 wt % graphitic carbon. The positive electrode can comprise a lithium metal oxide, conductive particulates, and a polymer binder. The electrolyte can comprise from about 1.1M to about 2.2M lithium salt and non-aqueous solvent, wherein the lithium salt comprises from about 60 mole percent to about 100 mole percent LiFSI, LiTFSI, or a mixture thereof, and wherein the non-aqueous solvent comprises from about 5 wt % to about 25 wt % fluoroethylene carbonate, 35 wt % to 90 wt % dimethyl carbonate, and from 0 to about 50 wt % diethyl carbonate, hydrofluoroether, fluoroalkyl carbonate, propylene carbonate, ethyl acetate, methyl acetate, propyl acetate, or mixtures thereof, wherein the weight percent values are relative to the solvent. The cell can exhibit a discharge specific capacity at a rate of 4 C of at least about 120 mAh/g between 2.5V and a selected charge voltage based on the weight of the cathode active material and wherein the impedance is no more than about 10 mOhms at the 600th cycle at a state of charge of 30%.

In another aspect, the invention pertains to a lithium ion cell comprising a negative electrode, a positive electrode, a separator between the negative electrode and the positive electrode, an electrolyte, and a container enclosing the negative electrode, the positive electrode, the separator and the electrolyte. The negative electrode can comprise from about 75 wt % to about 96 wt % an active material from about 0.1 wt % to about 7 wt % nanoscale conductive carbon and from about 4 wt % to about 20 wt % polymer binder, wherein the active material comprises from about 45 wt % to about 100% silicon-based active material, and from 0 to about 55 wt % graphitic carbon. The positive electrode can comprise a lithium metal oxide, conductive carbon, and a polymer binder. The electrolyte can comprise from about 1.1M to about 2.2M lithium salt and non-aqueous solvent, wherein the lithium salt comprises from about 60 mole percent to about 100 mole percent LiFSI, LiTFSI, or a mixture thereof, and wherein the non-aqueous solvent comprises from about 5 wt % to about 25 wt % fluoroethylene carbonate, 35 wt % to 90 wt % dimethyl carbonate, and from 0 to about 50 wt % diethyl carbonate, hydrofluoroether, fluoroalkyl carbonate, propylene carbonate, ethyl acetate, methyl acetate, propyl acetate, or mixtures thereof, wherein the weight percent values are relative to the solvent. The cell can exhibit a discharge capacity at a 5 C discharge to 2.5V from a specified charge voltage of at least about 90 mAh/g based on the weight of the cathode active material and a pulse power density at a rate of 5 C for a pulse of 30 second at a state of charge of 30% of at least about 2.0 kW/kg.

### BRIEF DESCRIPTION OF THE DRAWINGS

FIG. 1A is an exploded view of a pouch battery with a battery core separated from two portions of the pouch case.

FIG. 1B is a perspective lower face view of the assembled pouch battery of FIG. 1A.

FIG. 1C is a bottom plan view of the pouch battery of FIG. 1B.

FIG. 1D is a depiction of an embodiment of a battery core comprising an electrode stack.

FIG. 2 is a plot of specific capacity as a function of cycle at various charge/discharge rates, for coin cells prepared with electrolytes E1, E13 and E19. The electrode active materials were NMC622 for the positive active material and silicon oxide composite SOC for the negative active material.

FIG. 3 shows combined plots of conductivity and viscosity as a function of increasing concentration of LiFSI (left to right), for electrolytes E4-E8, with LiPF₆ remaining constant.

FIG. 4 is a plot of specific capacity as a function of cycle at various discharge rates for coin cells prepared with electrolytes E5-E7 and E17. The electrode active materials were NMC622 for the positive active material and silicon oxide composite SOC for the negative active material.

FIG. 5 is a plot of specific capacity at various charge rates for coin cells prepared with electrolytes E5-E7 and E17. The electrode active materials were NMC622 for the positive active material and silicon oxide composite SOC for the negative active material.

FIGS. 6A-6D are plots of specific capacity as a function of cycle number for coin cells prepared with electrolytes E5, E6, E7 and E17, respectively. The coin cells were cycled with a 4 C charge/1 C discharge rate. The electrode active materials were NMC622 for the positive active material and silicon oxide composite SOC for the negative active material.

FIG. 7 is a plot of specific capacity as a function of cycle at various charge/discharge rates for coin cells prepared with electrolytes E2, E3, E7, E9, E17 and E18. The electrode active materials were NMC811 for the positive active material and silicon oxide composite SOC for the negative active material.

FIG. 8 is a plot of specific capacity as a function of cycle number for coin cells prepared with electrolytes E9, E14-16 and E20-E22. The coin cells were cycled with at various charge/discharge rates. The electrode active materials were NMC811 for the positive active material and silicon oxide composite SOC for the negative active material.

FIGS. 9A-9G are plots of specific capacity as a function of cycle number for coin cells prepared with electrolytes E7, E9, E14, E15, E20, E21 and E22, respectively. The coin cells were cycled with a 1 C charge/1 C discharge rate. The electrode active materials were NMC811 for the positive active material and silicon oxide composite SOC for the negative active material.

FIG. 10 is a plot of power as a function of state of charge plotted as the cell voltage for large format pouch cells prepared with electrolytes E7, E9-E12 and E17. The pouch cells were designed to have a total capacity of about 12 Ah. The cells were discharged at rate of 1 C at 30° C. At every discharge of 10%, the cell was given a 5 C pulse for 30 seconds to determine the power output. The electrode active materials were NMC811 for the positive active material and silicon oxide composite SOC for the negative active material.

FIGS. 11A-11E are plot of normalized specific capacity as a function of cycle number for large format pouch cells prepared with electrolytes E7, E9, E10, E11 and E12, respectively. The pouch cells were designed to have a total capacity of about 12 Ah at a charge/discharge rate of 1 C at 30° C. The pouch cells were cycled with a 1 C charge/1 C discharge rate, and the data were normalized to the specific capacity obtained at C/3 charge rate. The electrode active materials were NMC811 for the positive active material and silicon oxide composite SOC for the negative active material.

FIGS. 11F-11J are plots of normalized specific capacity as a function of cycle number for the large format pouch cells described for FIGS. 11A-11E, respectively, except that the pouch cells were cycled with a 3 C charge (20 minutes constant current+constant voltage charge)/1 C discharge rate with a cap check at C/3 rate every 48 cycles.

FIG. 12 is a plot of capacity as a function of cycle number for a large format pouch cell prepared with electrolyte E9. The pouch cell was designed to have a total capacity of about 12 Ah at a charge/discharge rate of 1 C at 30° C. The pouch cell was cycled with a 1 C charge/1 C discharge rate. The electrode active materials were NMC811 for the positive active material and silicon oxide composite SOC for the negative active material.

FIG. 13A is a plot of normalized specific capacity as a function of cycle number for coin cells prepared with electrolytes E7 and E7. The coin cells were cycled with a 1 C charge/1 C discharge rate. The electrode active materials were NMC811 for the positive active material and silicon oxide composite SOC for the negative active material.

FIG. 13B is a plot of Coulombic efficiency as a function of cycle number for the coin cells described for FIG. 13A.

FIG. 14A is a plot of normalized capacity as a function of cycle number for a large format pouch cell prepared with electrolyte E7. The pouch cell was designed to have a total capacity of about 32 Ah at a discharge rate of C/3 at 30° C. The pouch cell at 30° C. was cycled with a 1 C charge/1 C discharge rate. The electrode active materials were NMC811 for the positive active material and silicon oxide composite SOC for the negative active material.

FIG. 14B is a plot of resistance as a function of percent SOC at different cycles, ranging from 0 cycles to 900 cycles, for the pouch cell described for FIG. 14A. The pouch cell was cycled with a 1 C charge/1 C discharge rate with a 1 C hybrid pulse power characterization (HPPC) pulse taken every 100 cycles.

FIG. 15A is a plot of voltage as a function of capacity for a large format pouch cell prepared with electrolyte E7. The pouch cell was designed to have a total capacity of about 32 Ah at a discharge rate of C/3 at 30° C. The pouch cell at 30° C. was cycled with a C/3 charge and discharge rates from C/10 to 12 C. The electrode active materials were NMC811 for the positive active material and silicon oxide composite SOC for the negative active material.

FIG. 15B is a plot of voltage as a function of capacity for the pouch cell described for FIG. 15A. The pouch cell was cycled at different charge rates ranging from 1 C to 6 C.

### DETAILED DESCRIPTION OF THE INVENTION

The lithium-ion cells described here have particular ability to produce high power (fast discharge rate) and fast charge, while also exhibiting high energy, and long cycle life. Lithium-ion cells have been developed using novel electrolyte formulations that impart improved cycle life, fast charge and high power output capability. The electrolytes incorporate lithium salt blends with selected organic solvents that provide particularly good rate and cycling properties in the discovered combinations. Lithium-ion cells described generally use electrodes comprising nickel rich cathode paired with an electrode comprising SiOx-graphite composite. Various SiOx anode formulations have been described in previous patent applications to achieve long cycle life while maintaining high energy. In this work, lithium-ion cells have been developed using electrolyte formulations that improve cycle life, fast charge cycling and high power output capability. For some applications, it is desirable for the cells to power capacity over a broad range of state-of-charge. For example, for a cell powered flying vehicle, a high power is used during landing to provide a safe and comfortable landing experience. The availability of high power at later stages of cell discharge provides significant potential of range within safety parameters.

Desirable electrolytes are based on mixture of salts, that generally comprise a lesser amount of lithium hexafluorophosphate (LiPF₆) combined with a greater amount of lithium bis(fluorosulfonyl)imide (LiFSI, LiN(SO₂F)₂), lithium bis(trifluoromethane)-sulfonimide

(LiTFS1, LiN(SO₂CF₃)₂) or mixtures thereof. For the negative electrode chemistries based on silicon suboxide composites and these salts effective organic solvents can comprise a blend of fluoroethylene carbonate (FEC) and dimethyl carbonate (DMC) which can optionally further comprise linear fluoroalkyl carbonate, hydrofluoroether, propylene carbonate (PC), alkyl acetates or mixtures thereof. With respect to the specified organic solvents, DMC is generally present in at least 35 percent (wt %). Weight percent values for the solvent constituents are relative to the total weights for the solvent. Electrolyte formulations can also use different types of additives in lesser amounts to enhance certain performance characteristics. Based on these high rate electrolytes, extremely high rates of discharge and charge can be achieved with maintenance of good cycling performance. Throughout this application and claims, unless specifically indicated otherwise, all electrochemistry results are at room temperature.

The electrolytes described herein are engineered to provide significant properties needed to have commercial cells using a relatively large fraction of silicon-based negative electrode active material. Applicant has been able to achieve suitable cycling of silicon based negative electrodes for vehicle application of secondary lithium ion cells. The improved electrolytes allow for high discharge rates along with fast charging and significantly reduced gassing, while maintaining good cycling for cells with relatively large amounts of silicon-based active material. The cells also exhibit relatively constant impedance over a significant depth of discharge so that high power pulses can be delivered at relatively low state of charge values. Such, high power pulse capability is significant for certain applications, such as landing of flying vehicles, where a high power pulse is needed at landing, which is after significant cell discharge has occurred.

In some embodiments, the improved electrolytes comprise a mixture of lithium salts including LiTFSI and LiPF₆, or LiFSI and LiPF₆, with a majority LiTFSI or LiFSI. Blends of LiFSI and LiPF₆ can be particularly desirable with the solvents described herein for good cycling for high power applications with high rate discharge. Applicant has found that some FEC as a solvent component is very helpful for cycling cells based on silicon suboxide composite chemistry.

See, for example, published U.S. patent application 2017/0194627 to Deng et al., entitled “Silicon Oxide Based Negative Electrode Materials for Lithium Ion Batteries,” incorporated herein by reference. Generally, additional additives may be included for safety concerns and/or to further reduce gassing. Applicant has discovered additional electrolytes that exhibit good high power performance which are based primarily on blends of LiPF₄ and LiTFSI in a solvent blend based primarily on FEC and EMC with optional additives. See, U.S. patent application Ser. No. 17/831,180 to Dong et al. (hereinafter the '180 application), entitled “Lithium Ion Cells With High Performance Electrolytes and Silicon Oxide Active Materials Achieving Long Cycle Life, Fast Charge and High Thermal Stability,” incorporated herein by reference.

Properties of various lithium salts are shown in Table 1. Properties of LiFSI are described in Han et al. Journal of Power Sources, 2011, 196, 3623. LiFSI is thermally stable up to 200° C. and when used in battery constructions comprising aluminum, the aluminum is found to be stable in the high potential region (3.0-5.0V versus Li+/Li). LiFSI has the highest ionic conductivity as measured for solutions including lithium salts in ethylene carbonate (EC) and EMC at 30/70 volume % (LiFSI>LiPF₆>LiTFSI>LiClO₄>LiBF₄). Selected properties of lithium tetrafluoroborate (LiBF₄) and lithium perchlorate (LiClO₄) are also included in Table 1.

TABLE 1

| | LiFSI | LiTFSI | LiPF₆ | LiBF₄ | LiClO₄ |
|---|---|---|---|---|---|
| Molecular weight (g/mol)¹ | 187 | 287 | 152 | — | — |
| Ionic Conductivity (mS/cm)¹ | 9.8 | 6.8 | 8.0 | — | — |
| Thermal Decomposition | 308 | 337 | 154 | — | — |
| Temperature (° C.)¹ | | | | | |
| Molecular Radius (Å)¹ | 3.5 | 4.7 | 2.7 | — | — |
| Ionic Conductivity (mS/cm) in | 10.7 | 8.2 | 9.8 | 3.9 | 6.2 |
| 30/70 (w/w) EC/EMC² | | | | | |

¹Source: Nippon Shokubai Co., Ltd. 1M salts in 3:7 (v:v) ethylene carbonate (EC):ethylmethyl carbonate (EMC).
²Source: Arkema, 1M salts

In some desirable embodiments, the electrolytes comprise lithium salts at a concentration from about 1.1M to about 2.5M in a non-aqueous solvent, and in further embodiments, from about 1.2M to about 2.2M, and in other embodiments, from about 1.3M to about 2.1M, or from about 1.7M to about 2.5M. The lithium salts generally comprise (LiTFSI or LiFSI) and LiPF₆ in a molar ratio from about 40:1 to about 1.5:1, in further embodiments from about 25:1 to about 2:1, or in some embodiments from about 20:1 to about 3:1. The respective amounts of the lithium salts can be similarly expressed as separate molarity ranges. Thus, LiPF₆ can have a concentration from about 0.05M to about 0.8M, in further embodiments from about 0.1M to about 0.5M and in additional embodiments form about 0.15M to about 0.4M. LiFSI and/or LiTFSI can have concentrations from about 0.8M to about 2.4M, in further embodiments from about 0.9M to about 2.2M, in additional embodiments from about 1.0M to about 2.1M, and in some embodiments from about 1.05M to about 2.0M. The electrolyte can optionally comprise additional lithium salts in an amount of less than about 10 mole percent, in further embodiments no more than about 6 mole percent and in additional embodiments no more than about 5 mole percent of the total lithium salts and in some embodiments are not present. Examples of suitable lithium salt additives are described below within a more comprehensive additive list. A person of ordinary skill in the art will recognize that additional ranges of salt concentrations and ratios of concentrations within the explicit ranges above are contemplated and are within the present disclosure, including but not limited to ranges with interchanged upper and lower limits, such as 0.1M to 0.4 M for LiPF₆.

The non-aqueous solvent generally comprises a blend of solvents. The solvent blend consists essentially of fluoroethyelene carbonate (C₃O₃H₃F, cyclic carbonate ester, FEC), dimethyl carbonate (DMC), optional cosolvents and optional additives. The total amounts of FEC, DMC and cosolvents are evaluated as weight percent values with the total being 100 vol %, and optional additives are referenced as weight percents relative to the total electrolyte weight, and the optional additives may or may not be liquids. The organic solvent can comprise from about from about 5 wt % to about 25 wt % FEC, in further embodiments from about 7 wt % to about 20 wt % FEC, and in additional embodiments from about 8 wt % to about 18 wt %, and in some embodiments form about 9 wt % to about 16 wt % FEC. The organic solvent generally comprises from about 35 wt % to about 95 wt % DMC, in further embodiments from about 38 wt % to about 92 wt %, and in additional embodiments from about 40 wt % to about 90 wt %. If a further cosolvent is present, lower amounts of DMC would be used, while if no further cosolvent is present larger amounts of DMC would be used. Optional cosolvents include diethyl carbonate, linear fluorocarbonates, hydrofluoroethers, propylene carbonate (cyclic carbonate ester, 4-methyl 1,3-dioxolan-2-one), alkyl acetate (methyl acetate, ethyl acetate, propyl acetate, or a mixture thereof), or a mixture thereof. Acyclic (dialkyl) fluorocarbonates can include, for example, methyl 2,2,2-trifluoroethyl carbonate (FEMC, CF₃CH₂O(CO)OCH₃). Hydrofluoro ethers are generally ethers with partial fluorine substitution, and representative compounds include, for example, IH,IH,5H-octafluoropentyl-1,1,2,2-tetrafluoroethyl ether, 1,1.2.2- tetrafluoroethyl-2,2,2-trifluoroethyl ether, or 1,1,2,2-tetrafluoroethyl-2,2,3,3-tetrafluoropropyl ether, or mixtures thereof. Suitable hydrofluoroethers for electrolytes are described further in published U.S. patent application 2022/0216518 to Li et al., entitled “Electrolyte for Lithium Ion Battery, Lithium Ion Battery, Battery Module, Battery Pack and Apparatus,” incorporated herein by reference. The cosolvents can be present, for individual compounds or blends thereof, in amounts from about 5 wt % to about 60 wt %, in further embodiments from about 7 wt % to about 58 wt %, in other embodiments from about 8 wt % to about 55 wt %, in additional embodiments from about 9 wt % to about 50 wt % and in some embodiments from about 10 wt % to about 45 wt %. For some embodiments, the solvent can comprise from about 35 wt % to about 55 wt % fluoro dialkyl carbonate, hydrofluoro ether of a mixture thereof. For some embodiment, the solvent can comprise from about 9 wt % to about 35 wt % propylene carbonate, alkyl acetate or a mixture thereof. A person of ordinary skill in the art will recognize that additional range within the explicit ranges of solvent component concentrations above are contemplated and are within the present disclosure, including ranges that involve exchange of corresponding upper and lower limits for each other.

With respect to the electrolyte terminology, many embodiments have a basic composition along with optional additives for the salt and other non-salt additives. To the extent that the electrolyte composition consists of a specific composition, the adjustable additives allow for variation around the basic composition to provide for adjustment of the properties. If the composition is indicated to consist essentially of a particular composition, herein, that is intended to mean that any additives do not significantly change the electrochemical properties, but other properties, such as out gassing, thermal stability, anti-flammability, and the like may be different.

Electrolyte additives can provide antigassing effects, reduce flammability and/or provide other safety effects. Any additives should be selected to help maintain desired cycling stability.

Suitable additives of interest include, for example: an anti-flammability additive (such as triethyl phosphite (TEP), trimethyl phosphite (TMP), triphenyl phosphite (TPP), pentafluoro(phenoxy)cyclotriphosphazene (PFPCTP), ethoxy(pentafluoro)cyclotriphosphazene (EPFCTP, C₂H₅F₅N₃OP₃) or hexaphenoxycyclotriphosphazene (HPCTP)); an anti-gassing agent (such as vinylene carbonate (VC); 4-vinyl-1,3-dioxolan-2-one (VEC); 1,3-propane sultone (PS, C₃H₆SO₃); prop- 1-ene-1,3-sultone (PES); 1,3,2-dioxathiolane 2,2-dioxide (DTD); lithium difluorophosphate (LiDFP, TEP, TMP or TPP); an HF scavenger (such as fluorobenzene (FB); succinonitrile (SN) or lithium 4,5-dicyano-2-(trifluoromethyl)imidazole (LiTDI)); a solid electrolyte interphase (SEI) modifier at the anode active material surface (such as VC; VEC; lithium bis(oxalato)borate (LiBOB); lithium difluoro(oxalato)borate (LiDFOB); trimethyl borate (TMB); LPTB (lithium 4-pyridyl trimethyl borate)), or mixtures thereof. Some additives may also influence the formation of a cathode electrolyte interface (CEI), (such as LiDFP, LiBOB or LiDFOB). Some additives may provide multiple influences on performance. Any additive with a lithium ion can be considered a lithium salt additive with concentration limits as specified for lithium salt additives, and other additives are considered within the general grouping of additives and the corresponding limits for such additives provided herein. A person of ordinary skill in the art will recognize that additional ranges of electrolyte constituents within the explicit ranges above are contemplated and are within the present disclosure.

Applicant has achieved very good cycling of silicon-based electrodes using previously developed electrolytes as described in published U.S. patent application 2020/0411901 to Dong et al. (hereinafter the '901 application), entitled “Lithium Ion Cells with High Performance Electrolyte and Silicon Oxide Active Materials Achieving Very Long Cycle Life Performance,” incorporated herein by reference. While the '901 application achieved important breakthroughs in cycle life performance for silicon-based cells, the results herein are directed to achievement of high discharge power and high rate charging, while maintaining high energy and good cycling performance. A reference electrolyte used in the Examples is similar to an electrolyte from the '901 application) and is referred to as E17, with no particular significance to the nomenclature. Also, Applicant has described similar electrolytes in the '180 application cited above. The electrolytes described herein are particularly effective for very high power performance for the active materials described while still achieving long cycle life.

In some embodiments, the electrolyte formulations described in this work show better rate performance, while exhibiting similar or better cycle life, than a reference electrolyte formulation consisting of LiPF₆ salt in FEC and DMC solvents. As exemplified herein, a family of electrolytes have formulations with a blend of LiPF₆ and (LiTFSI or LiFSI) salts in solvents comprising FEC and (DMC or fluorinated EMC (FEMC) or a blend of DEC and HFE, highly fluorinated ethylene), optional PC and optional MA [or EA]. These exemplified electrolytes suggest other variations within these explicit ranges taught.

As exemplified herein, some specific embodiment include a family of electrolytes having formulations with a blend of lithium salts, LiTFSI and LiPF₆, or LiFSI and LiPF₆, in solvents comprising FEC and one or more additional solvents selected from the group consisting of DMC, fluorinated ether, fluorinated carbonate, PC, alkyl acetate, and mixtures thereof. The presence of higher concentrations of DEC generally results in a significant drop in high rate performance. The one or more additional solvents may consist essentially of DMC. The one or more additional solvents may consist essentially of DMC, PC and alkyl acetate. The one or more additional solvents may comprise a hydrofluorinated ether (HFE), or consist essentially of one or more HFEs. The one or more additional solvents may consist essentially of fluorinated ether, fluorinated dialkyl carbonate or a mixture thereof. The one or more additional solvents may consist essentially of fluorinated ether such as 1H,1H, 5H-octafluoropentyl 1,1,2,2-tetrafluoroethyl ether (OTE). Other fluorinated ethers include 1,1,2,2-tetrafluoroethyl 2,2,3,3-tetrafluoropropyl ether (TTE); bis(2,2,2-trifluoroethyl) ether (BTFE) and ethyl 1,1,2,2-tetrafluoro-ethyl ether (ETE). The one or more additional solvents may consist essentially of DMC and OTE.

The alkyl acetate used in any of the electrolytes described herein include methyl acetate, ethyl acetate, propyl acetate and mixtures thereof.

The batteries of particular current interest exhibit abilities for both fast charge and high power output, which are related concepts for charging versus discharging. Charging at rates up to 5 C and discharging at rates up to 12 C are exemplified. Specifically, high power is achieved through high rate discharge with appropriate energy, while fast charging is correspondingly operating the charging reactions at a fast rate. Charge capacities are rate dependent, and the cells should desirably have good rate capability on rapid charging indicative of good high rate performance. Charging can be performed at a constant current and then a relatively shorter constant voltage end to the charge step. The constant voltage charge can be stopped when the current falls below an appropriate value, such as below C/20 or C/50, which provides a value close to the target voltage. As with a discharge step, the capacity during charging is generally also rate dependent. So after a constant current charge, the open circuit voltage can be somewhat short of target once the constant current charging step is complete. The drop in voltage is dependent on the charging rate and charging capability of the cell, with less rate capable cells exhibiting a larger voltage drop. A relatively short lower current charge step can bump up the open current voltage to a desired value. For testing, the discharge rate can be selected to a desired high value to represent a high power discharge, corresponding to high current discharge. In the Examples, some results are presented based on a 3 C constant current charge followed by a 10 minute constant voltage charge, for a total charge time of 30 minutes, and other high rate charging is also exemplified.

Since the charge capacity depends on the rate or current, the use of the electrolytes described herein that improve rate capability facilitate fast charge. If a material is not rate capable is forced to charge at a high rate, the cycle performance can suffer and/or the material may not be able to achieve the target charge voltage in the allocated time. During the constant current charge, while increasing the rate shortens the time to get to the selected voltage at that rate, it can lengthen the time to complete the constant voltage part of the charge if the rate capability if low. If the rate capability is high, then a faster charge rate can be effective while not having too long of a constant voltage charge segment. Examples are presented with a 3 C constant current charge for 20 minutes and a 10 minute constant voltage charge. In some embodiments, a fifteen minute charge can be accomplished with a constant voltage charge period of no more than about 6 minutes, in further embodiments no more than about 5.5 minutes and in further embodiments no more than about 5 minutes. A person of ordinary skill in the art will recognize that additional range within the explicit ranges of constant voltage times above are contemplated and are within the present disclosure.

In actually use, the power output generally varies depending on the power demands of the application. So a high power discharge may be used during acceleration and deceleration, such as takeoff and landing for a flying vehicle, while cruising may be a low power operation. During landing in particular, to have a soft landing, there can be a very high power discharge (e.g., >10 C) for a short burst of time. Of course, landing is toward the end of a discharge cycle, so there needs to be sufficient capacity remaining to accept the large pulse discharge. Thus, it is highly desirable to exhibit both high power and high capacity at a reasonable state of charge (SOC), such as >50% discharge. Having high power capability then allows for safe extension of range without serious concerns about being deficient in remaining capacity to land. The electrolytes and corresponding cells described herein are designed for both fast charge and high power discharge. in exemplified embodiments, the cells are still formed using a first cycle (and optionally two or a few cycles) charge and discharge at a C/10 rate to form stable passivation layers on the active materials and prepare the cell for cycling at the subsequent cycles. One or more subsequent cycles can be performed at C/3 to complete a stable formation process.

In addition to high rate charging and discharging during cycling, additional high rate pulse tests have been performed. To perform the pulse test, first the cell is fully charged. Then, a 30 second pulse of a 5 C (rate for full discharge over 12 minutes) discharge is performed. Then, the cell is discharged to a 90% state-of-charge (SOC), and the 5 C, 30 second discharge pulse is applied again. This pulsing is repeated stepping down every 10% SOC. For each 5 C pulse, the power and resistance of the cell are calculated. Plots of these pulse studies are presented in the Examples. Desirable 5 C pulse power results at 50% SOC are at least 3 kW/kg. More generally, for a pouch cell with at least a 1 A capacity, a 5 C pulse power at 50% SOC is at least 2.0 kW/kg, in further embodiments at least about 2.5 kW/kg, in other embodiments at least about 2.75 kW/kg, and in additional embodiments form about 3.0 kW/kg to 4.25 kW/kg. This high power performance can be achieved simultaneously with a high energy density at discharge rates of C/3 of at least about 200 Wh/kg and in further embodiments from about 250 Wh/kg to about 375 Wh/kg. A person of ordinary skill in the art will recognize that additional ranges of power and energy density within the explicit ranges above are contemplated and are within the present disclosure.

Electronic vehicles are of significant interest for lithium ion cells for commercial application. Suitable vehicles include, for example, car, trucks, vans, sports utility vehicles, crossover styles, commercial trucks, construction equipment, utility vehicles, such as fork lifts or the like, flying occupied vehicles, such as personal air vehicles or the like, unoccupied land vehicles, such as tractors, people movers, or the like, unoccupied flying vehicles, such as drones or the like, and similar vehicles. High power cells can be useful for any high performance vehicles and can also be useful for power tool, some medical devices, and other high power applications.

For these applications, it can be desirable to use pouch style cells with flexible enclosures. With flexible enclosures, it can be desirable to incorporate the cells into a battery pack that holds the cells within a specified volume. Such a volume constraint effect is similarly exhibited in cells assembled within metal containers, such as coin cell embodiments used in the Examples and traditional cylindrical cells. The positioning of the cells in a pack can be the equivalent of clamping the cells to control disassembly of the electrode stack that could compromise cycling. In the examples below, cell expansion is examined for unclamped pouch cells to examine the effects of outgassing. In a constrained configuration, the cells are not able to expand, but outgassing expresses itself through an increase in pressure. An increase in pressure can be exacerbated by increases in temperature. For these reasons, the cycling performance at 45° C. can reflect the ability to control the outgassing.

### General Battery Features

The negative electrode and positive electrode structures can be assembled into appropriate cells. As described further below, the electrodes are generally formed in association with current collectors to form electrode structures. A separator is located between a positive electrode and a negative electrode to form a cell. The separator is electrically insulating while providing for at least selected ion conduction between the two electrodes. A variety of materials can be used as separators. Some commercial separator materials can be formed from polymers, such as polyethylene and/or polypropylene that are porous sheets that provide for ionic conduction. Commercial polymer separators include, for example, the Celgard® line of separator material from Celgard, LLC, a subsidiary of Asahi Kasei (Japan). Also, ceramic-polymer composite materials have been developed for separator applications. These ceramic composite separators can be stable at higher temperatures, and the composite materials can reduce the fire risk. Polymer-ceramic composites for lithium ion battery separators are sold by Celgard® as well as under the trademarks Separion® by Evonik Industries, Germany and Lielsort® by Tiejin Lielsort Korea Co., Ltd. Also, separators can be formed using porous polymer sheets coated with a gel-forming polymer. Such separator designs are described further in U.S. Pat. No. 7,794,511 B2 to Wensley et al., entitled “Battery Separator for Lithium Polymer Battery,” incorporated herein by reference. Suitable gel-forming polymers include, for example, polyvinylidene fluoride (PVDF), polyurethane, polyethylene oxide (PEO), polypropylene oxide (PPO), polyacylonitrile, gelatin, polyacrylamide, polymethylacrylate, polymethylmethacrylate, polyvinylacetate, polyvinylpyrrolidone, polytetraethylene glycol diacrylate, copolymers thereof, and mixtures thereof.

Electrolyte provides for ion transport between the anode and cathode of the battery during the charge and discharge processes. The electrolytes for lithium ion batteries incorporate non-aqueous solvents and lithium salts. Improved electrolytes for silicon based electrodes are described in detail below. The electrolytes generally are infused into the cell prior to sealing the case.

The electrodes described herein can be assembled into various commercial cell/battery designs such as prismatic shaped batteries, wound cylindrical cells, coin cells, or other reasonable cell/battery designs. The cells can comprise a single pair of electrodes (possibly wound or folded) or a plurality of pairs of electrodes assembled in parallel and/or series electrical connection(s). Electrode stacks can have an extra electrode to end the stack with the same polarity as the other end of the stack for convenience in placement in a container. While the electrode structures described herein can be used in batteries for primary, or single charge use, the resulting batteries generally have desirable cycling properties for secondary battery use over multiple cycling of the batteries.

In some embodiments, the positive electrode and negative electrode can be stacked with the separator between them, and the resulting stacked structure can be rolled into a cylindrical or prismatic configuration to form the cell structure. Appropriate electrically conductive tabs can be welded or the like to the current collectors, and the resulting jellyroll structure can be placed into a metal canister or polymer package, with the negative tab and positive tab welded to appropriate external contacts. Electrolyte is added to the canister, and the canister is sealed, possibly after formation cycling, to complete the cell. Some presently used rechargeable commercial cells include, for example, the cylindrical 18650 cells (18 mm in diameter and 65 mm long) and 26700 cells (26 mm in diameter and 70 mm long), although other cell/battery sizes can be used, as well as prismatic cells and foil pouch cells/batteries of selected sizes.

Pouch batteries can be particularly desirable for various applications, including certain vehicle applications, due to stacking convenience and relatively low container weight. A pouch battery design for vehicle batteries incorporating a high capacity cathode active material is described further in U.S. Pat. No. 8,187,752 to Buckley et al, entitled “High Energy Lithium Ion Secondary Batteries” and U.S. Pat. No. 9,083,062B2 to Kumar et al., entitled “Battery Packs for Vehicles and High Capacity Pouch Secondary Batteries for Incorporation into Compact Battery Packs,” both incorporated herein by reference. While the pouch battery designs are particularly convenient for use in specific battery pack designs, the pouch batteries can be used effectively in other contexts as well.

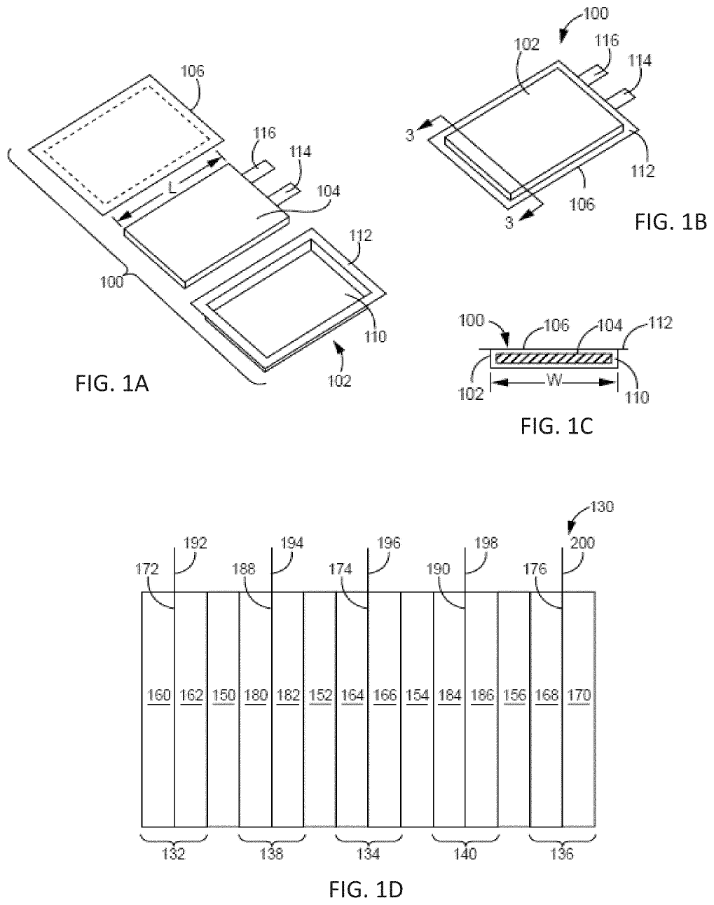

A representative embodiment of a pouch battery is shown in FIGS. 1A to 1D. In this embodiment, pouch battery 100 comprises pouch enclosure 102, electrode core 104 and pouch cover 106. An electrode core is discussed further below. Pouch enclosure 102 comprises a cavity 110 and edge 112 surrounding the cavity. Cavity 110 has dimensions such that electrode core 104 can fit within cavity 110. Pouch cover 106 can be sealed around edge 112 to seal electrode core 104 within the sealed battery, as shown in FIGS. 1B and 1C. Terminal tabs 114, 116 extend outward from the sealed pouch for electrical contact with electrode core 104. FIG. C is a schematic diagram of a cross section of the battery of FIG. 1B viewed along the 3-3 line. Many additional embodiments of pouch batteries are possible with different configurations of the edges and seals.

FIG. 1D shows an embodiment of an electrode core 104 that generally comprise an electrode stack. In this embodiment, electrode stack 130 comprises negative electrode structures 132, 134, 136, positive electrode structures 138, 140, and separators 150, 152, 154, 156 disposed between the adjacent positive and negative electrodes. The separator can be provided as a single folded sheet with the electrode structures placed in the separator folds. Negative electrode structures 132, 134, 136 comprise negative electrodes 160, 162, negative electrodes 164, 166 and negative electrodes 168, 170, respectively, disposed on either side of current collectors 172, 174, 176. Positive electrode structures 138, 140 comprise positive electrodes 180, 182 and positive electrodes 184, 186, respectively, disposed on opposite sides of current collectors 188, 190, respectively. Tabs 192, 194, 196, 198, 200 are connected to current collectors 172, 188, 174, 190, 176, respectively, to facilitate the connection of the individual electrodes in series or in parallel. For vehicle applications, tabs are generally connected in parallel, so that tabs 192, 196, 200 would be electrically connected to an electrical contact accessible outside the container, and tabs 194, 198 would be electrically connected to an electrical contact as an opposite pole accessible outside the container.

Electrode stacks can have an extra negative electrode such that both outer electrodes adjacent the container are negative electrodes. Generally, a battery with stacked electrodes of the dimensions described herein have from 5 to 40 negative electrode elements (current collector coated on both sides with active material) and in further embodiments from 7 to 35 negative electrode elements with corresponding numbers of positive electrode elements being generally one less than the negative electrode elements. A person of ordinary skill in the art will recognize that additional ranges of electrode numbers within the explicit ranges above are contemplated and are within the present disclosure.

As noted above, wound electrodes can be correspondingly used for either a cylindrical battery or a roughly prismatic shaped battery. Wound cells for cylindrical lithium ion batteries are described further in U.S. Pat. No. 8,277,969 to Kobayashi et al., entitled “Lithium Ion Secondary Battery,” incorporated herein by reference. Prismatic shaped batteries with wound electrodes are described in U.S. Pat. No. 7,700,221 to Yeo (the '221 patent), entitled “Electrode Assembly and Lithium Ion Secondary Battery Using the Same,” incorporated herein by reference. The Kobayashi '969 patent and the Yeo '221 patent do not describe how to achieve reasonable cycling or a high energy density with silicon based active materials. Designs for prismatic shaped batteries with wound electrodes are described further, for example, in the '221 patent cited above. A particular design of either a stacked set of electrodes or a wound cell can be influenced by the target dimensions and the target capacity of the battery.

The improved negative electrodes can be used for a range of applications and cell/battery designs. For electrode stacks, the areas of the electrodes can be selected reasonably based on the volume and design constraints for the particular application. The following discussion focuses on larger cells generally designed for vehicle applications, such as drones, automobiles, trucks, or other vehicles. However, the improved negative electrodes described herein can be effectively used for consumer electronics applications, which can be based on smaller cell formats. Also, it should be noted that vehicles can use smaller consumer electronics cells, and Tesla cars presently are famous for using thousands of small consumer electronics cells in their battery packs. Generally, larger format cells/batteries can achieve larger energy densities within certain ranges. It may be desirable to select positive electrode active materials based on the particular application to balance various considerations, such as energy densities.

With the selection of electrode parameters, the design of high gravimetric energy density cells can incorporate a balance of factors including electrode area, the number of electrode structures, and battery capacity. The electrode area refers to the spatial extent of one of the electrodes along one side of a current collector. FIG. A depicts the length “L”, and FIG. C depicts the width “W” of an electrode. As shown in the Figures, the area of an electrode can be defined as L×W. In some embodiments, the area of each electrode can be similar such that the dimensions of a battery comprising an electrode stack can have a length and width that are similar to the length and width of each electrode in the stack. In some embodiments, the separator can be in sheets with an area slightly larger than the area of the electrode, and in some embodiments, the separator can be folded, pleated or formed with pockets in which the electrodes are placed in folds or the pocket of the separator.

### Electrode Structures

The electrodes of the cell comprise the active material along with a binder and conductive additives. The electrodes are formed into a sheet, dried and pressed to achieve a desired density and porosity. The electrode sheets are generally formed directly on a metal current collector, such as a metal foil or a thin metal grid. For many cell structures, electrode layers are formed on both sides of the current collector to provide for desirable performance in the assembled cell or battery. The electrode layers on each side of the current collector can be considers elements of the same electrode structure since they are at the same potential in the cell, but the current collector itself, while part of the electrode structure is not generally considered part of the electrode since it is electrochemically inert. Thus, references to the physical aspects of an electrode generally refer to one layer of electrode composition within the electrode structure. An electrically conductive current collector can facilitate the flow of electrons between the electrode and an exterior circuit.

In some embodiments, when the positive electrode or negative electrode uses a high loading level, the density of the electrode can be reduced to provide good cycling stability of the electrode. The density of the electrodes is a function, within reasonable ranges, of the press pressures. Generally, the density of the electrodes cannot be arbitrarily increased without sacrificing performance with respect to loading levels while achieving desired cycling performance and capacity at higher discharge rates. The characterization of the specific negative electrode layers and positive electrode layers are presented in the following sections.

In some embodiments, a current collector can be formed from nickel, aluminum, stainless steel, copper or the like. An electrode material can be cast as a thin film onto a current collector. The electrode material with the current collector can then be dried, for example in an oven, to remove solvent from the electrode. In some embodiments, a dried electrode material in contact with a current collector foil or other structure can be subjected to a pressure from about 2 to about 10 kg/cm² (kilograms per square centimeter). The current collector used in the positive electrode can have a thickness from about 5 microns to about 30 microns, in other embodiments from about 10 microns to about 25 microns, and in further embodiments from about 14 microns to about 20 microns. In one embodiment, the positive electrode uses an aluminum foil current collector. The current collector used in the negative electrode can have a thickness from about 2 microns to about 20 microns, in other embodiments from about 4 microns to about 14 microns, and in further embodiments from about 6 microns to about 10 microns. In one embodiment, the negative electrode uses copper foil or nickel foil as current collector. A person of ordinary skill in the art will recognize that additional ranges of current collector thicknesses within the explicit ranges above are contemplated and are within the present disclosure.

### Negative Electrodes

The basic electrode design comprises one or a blend of active compositions, polymer binder, and an electrically conductive diluent. As noted above, in some embodiments, improved electrode designs can involve a polymer binder blend and optionally a blend of active compositions as well as nanoscale conductive carbon additives. While the active material can be solely a silicon based material or composite, an active material blend can comprise in some embodiments a majority of silicon based active material, such as a silicon oxide composite, and at least 2.5 weight percent of distinct graphite or in some embodiments at least about 4 wt % graphite. A general description of high capacity silicon based active material is found in U.S. Pat. No. 9,190,694 to Lopez et al. (hereinafter the '694 patent), entitled “High Capacity Anode Materials for Lithium Ion Batteries,” incorporated herein by reference.

Also, it has been discovered that stabilization of the electrode cycling with silicon based active materials can obtained with a binder that is solvent based or water based. While any graphite can provide electrical conductivity to the electrode, it has also been found that in some embodiments a quantity of distinct nanoscale conductive carbon nevertheless can be significant toward the ability to produce a long cycling negative electrode. In general, the nanoscale conductive carbon is not believed to be electrochemically active while the graphite can be electrochemically active. These improved design aspects are then incorporated into electrodes with further previously discovered silicon based electrode improvements.

Significant interest has been directed to high capacity negative electrode active material based on silicon. Silicon based active materials generally have not achieved suitable cycling stability for automotive use for batteries containing significant quantities of silicon. With silicon-based active materials, Applicant has demonstrated successful cycling suitable for consumer electronics applications and the like with cycling up to around 200-300 cycles at values of at least 80% initial capacity, see published U.S. patent application 2015/0050535 to Amiruddin et al., entitled “Lithium Ion Batteries With High Capacity Anode Active Materials for Consumer Electronics,” incorporated herein by reference. Applicant has had particular success with respect to cycling stability has been achieved using materials primarily based on silicon oxide composites. With previous electrolyte formulations, Applicant has used effective electrode designs that can be successfully cycled for more than 800 cycles without a drop in capacity below 80% with cycling over a large voltage range at a reasonable rate, see the '901 application cited above. Thus, the present work is directed to maintaining cycling stability into a realm suitable for vehicle use, while providing very high rate capability.

As described herein, good cycling results are obtained with a blended active composition with a silicon based active material and graphitic carbon. Generally, an overall capacity of the negative electrode blended active material can be at least about 750 mAh/g, in further embodiments at least about 900 mAh/g, in additional embodiments at least about 1000 mAh/g, and in other embodiments at least about 1100 mAh/g cycled against lithium metal from 5 millivolts (mV) to 1.5V at a rate of C/3. While a silicon based active material, such as a SiO/Si/C composite, can be used as the sole anode active material, a blended active material can comprise at least about 40 wt % silicon based active material, in further embodiments at least about 50 wt % silicon based active material, in other embodiments from about 55 wt % to about 99 wt % silicon based active material, and in additional embodiments from about 60 wt % to about 95 wt % silicon based active material. Correspondingly, the blended active material can comprise from about 1 wt % graphite to about 65 wt % graphite, in further embodiments from about 2 wt % graphite to about 60 wt % graphite, in additional embodiments from about 3 wt % graphite to about 55 wt %, and in other embodiments from about 5 wt % graphite to about 50 wt % graphite. Desirable graphites are described below. A person of ordinary skill in the art will recognize that additional ranges of specific discharge capacity and concentrations of silicon based active material within the explicit ranges above are contemplated and are within the present disclosure.

As noted above and described in detail below, suitable silicon based active materials can comprise a composite with a carbon component. Silicon based active materials are discussed in detail in the following section. A composite refers to a particulate material with components that are intimately combined into an integral material with effective uniformity over appropriate scales, in contrast with blends that involve mixtures held together with a polymer binder. Composite components that can comprise, for example, silicon, oxygen, carbon and the like. While not wanting to be limited by theory, it is not generally believed that a carbon component of a composite with silicon is active in electrochemistry and generally not graphitic, although the activity is an abstract concept given the intimate combination in the composite and the crystal structure may be extremely complex and difficult to evaluate. In any case, the carbon component of a composite material is readily understood by a person of ordinary skill in the art to be distinguishable from the distinct graphite not in a composite in active material blends. The examples below are based on a commercial composite composition believed to be comprising primarily of silicon suboxide with some amounts of elemental silicon crystals and elemental carbon in a combined composite particulate material.

Graphite is available commercially in natural and synthetic forms, and suitable graphite includes either natural or synthetic graphite or the like. Graphite is a crystalline form of carbon with covalently bonded carbon in sheets. As used herein, graphite refers to graphitic carbon without requiring perfect crystallinity, and some natural graphite materials can have some crystalline impurities. But the graphite refers generally to a material dominated by a graphitic structure, as would be recognized in the art. Graphite is electrically conductive along the plane of the covalent carbon sheets that are stacked in the crystal. The crystalline carbon in graphitic forms can intercalate lithium, so that it is an established electrochemically active material for lithium ion batteries, although the graphite particle morphology can influence the efficacy of the graphite for lithium intercalation.

Graphite particles can have average particle diameters from about 1 micron to about 30 microns, in further embodiments from about 1.5 microns to about 25 microns, and in other embodiments from about 2 microns to about 20 microns. In general, it is desirable for the graphite to not include particles greater than the electrode thickness to avoid a bumpy electrode surface, and graphitic particles with a size significantly less than a micron can be less crystalline. In some embodiments, the graphitic carbon can have a D50 (mass median diameter) from about 5 microns to about 50 microns, in further embodiments from about 7 microns to about 40 microns and in additional embodiments from about 10 microns to about 8 microns to about 30 microns. Also, in some embodiments the BET surface area of graphitic carbon active material (which can be evaluated according to ISO 4652) can be from about 1 m²/g to about 50 m²/g, in further embodiments from about 1.5 m²/g to about 35 m²/g and in additional embodiments from about 2 m²/g to about 25 m²/g. A person of ordinary skill in the art will recognize that additional ranges of particle size and surface area for graphitic carbon active materials are contemplated and are within the present disclosure. In comparison, electrically conductive carbon blacks or the like (which have been referred to as paracrystalline) generally have surface areas of at least roughly 40 m²/g to 1000 m²/g or greater.

With respect to the polymer binder, Applicant has obtained reasonable cycling of silicon based cells using high tensile strength binders, e.g., polyimide binder. See U.S. Pat. No. 9,601,228 to Deng et al. (hereinafter the '228 patent) entitled: “Silicon Oxide Based High Capacity Anode Materials for Lithium Ion Batteries,” incorporated herein by reference. In some embodiments to obtain longer cycling stability, it has been surprisingly found that a polymer binder blend further stabilizes cycling. In particular, a second polymer or combination of polymers providing a lower elastic modulus (corresponding with greater elasticity) can be blended with high tensile strength polyimide. The binder blend generally comprises at least about 50 wt % polyimide, in further embodiments at least about 55 wt % and in other embodiments from about 60 wt % to about 95 wt % polyimide. Similarly, the binder blend generally comprises at least about 5 wt % polymer with a lower elastic modulus, in further embodiments at least about 10 wt %, and in other embodiments from about 12 wt % to about 40 wt % lower elastic modulus polymer, as specified further below. A person of ordinary skill in the art will recognize that additional ranges of polymer quantities within the explicit ranges above are contemplated and are within the present disclosure. The polymers of the blend can be selected to be soluble in the same solvents. Polymer blends effective to achieve good cycling of silicon-based anodes are summarized below and are described further in U.S. Pat. No. 11,094,925 to Venkatachalam et al. (hereinafter the '925 patent), entitled “Electrodes with Silicon Oxide Active Materials for Lithium Ion Cells Achieving High Capacity, High Energy Density and Long Cycle Life Performance,” incorporated herein by reference.

Polyimides are polymers based on repeat units of the imide monomer structure. The polyimide polymer chain can be aliphatic, but for high tensile strength applications, the polymer backbone generally is aromatic with the polymer backbone extending along the N-atom of the polyimide structure. For silicon-based anodes that exhibit significant morphological changes during cycling, thermally curable polyimide polymers have been found desirable for high capacity negative electrodes, which may be due to their high mechanical strength. Table 2 provides suppliers of high tensile strength polyimide polymers, and names of corresponding polyimide polymers.

TABLE 2

| Supplier | Binder |
|---|---|
| New Japan Chemical | Rikacoat PN-20; Rikacoat EN-20; |
| Co., Ltd. | Rikacoat SN-20 |
| DuPont | Kapton ® |
| AZ Electronic Materials | PBI MRS0810H |
| Ube Industries. Corp. | U-Varnish S; U-Varnish A |
| Maruzen petrochemical | Bani-X (Bis-allyl-nadi-imide) |
| Co., Ltd. | |
| Toyobo Co., Ltd. | Vyromax ® HR16NN |

The polyimide polymers can have a tensile strength of at least about 60 MPa, in further embodiments at least about 100 MPa and in other embodiments at least about 125 MPa. Some commercial polyimides with high tensile strength can also have relatively high elongation values, which is the amount of elongation tolerated before the polymer tears. In some embodiments, the polyimides can have an elongation of at least about 40%, in further embodiments at least about 50% and in other embodiments at least about 55%. Tensile strengths and elongation values can be measured according to procedures in ASTM D638-10 Standard Test Method for Tensile Properties of Plastics or ASTM D882-91 Standard Test Method for Tensile Properties of Thin Plastic Sheeting, both of which are incorporated herein by reference. Based on values reported by commercial suppliers, the results from these alternative ASTM protocols seem similar to each other for polyimides. A person of ordinary skill in the art will recognize that additional ranges of polymer properties within the explicit ranges above are contemplated and are within the present disclosure.

Suitable more flexible polymer components can be selected to be inert with respect to the electrochemistry of the cell and to be compatible with processing with the polyimide. In particular, suitable more flexible polymer components include, for example, PVDF, carboxy methylcellulose (CMC), styrene-butadiene rubber (SBR), lithiated polyacrylic acid (LiPAA), or mixtures thereof. With respect to polymer properties, some significant properties for high capacity negative electrode application are summarized in Table 3.

TABLE 3

| | | Tensile Strength | ElasticModulus |
|---|---|---|---|
| Binder | Elongation | (MPa) | (GPa) |
| PVDF | 5-50% | 30-45 | 1.0-2.5 |
| Polyimide | 30-100% | 60-300 | 2.5-7 |
| CMC | 30-40% | 10-15 | 1-5 |
| SBR | 400-600% | 1-25 | 0.01-0.1 |
| LiPAA | 1-6% | 90 | 1-4 |

PVDF, CMC, and SBR are available commercially from many sources. LiPAA can be made from LiOH and commercial polyacrylic acid (PAA). For example, a stoichiometric amount of LiOH can be added to a solution of PAA with one mole of LiOH per monomer unit of PAA. The formation and use of LiPAA is described further in Li et al., “Lithium polyacrylate as a binder for tin-cobalt-carbon negative electrodes in lithium-ion batteries,” Electrochemica Acta 55 (2010) 2991-2995, incorporated herein by reference.

The elongation refers to the percent elongation prior to tearing of the polymer. In general, to accommodate the silicon-based materials, it is desirable to have an elongation of at least about 30%, in some embodiments at least about 50%, and in further embodiments at least about 70%. For the polymer binder blend, it can be desirable for the more elastic polymer binder component to have an elastic modulus (alternatively referred to as Young's modulus or tensile modulus) of no more than about 2.4 GPa, in further embodiments no more than about 2.25 GPa, in other embodiments no more than about 2 GPa, and in additional embodiments no more than about 1.8 GPa. A person of ordinary skill in the art will recognize that additional ranges of more elastic polymer component properties within the explicit ranges above are contemplated and are within the present disclosure.

To form the electrode, the powders can be blended with the polymer in a suitable liquid, such as a solvent for dissolving the polymer. Polyimides and PVDF can generally be processed in N-methyl pyrrolidone (NMP), although other suitable organic solvents may be used. Water processable polyimides are commercially available, and these water processable polyimides are suitable for blending with a wider range of other polymers. The particulate components of the electrode, i.e., the active material and nanoscale conductive carbon, can be blended with the polymer binder blend in the solvent to form a paste. The resulting paste can be pressed into the electrode structure.

While the polymer binders described above have facilitated achievement of impressive cycling stability for silicon-based negative electrodes, water-based polymer binders have been developed that can achieve comparable or better cycling performance. In some embodiments, a polymer binder that is water processable is a copolymer of acrylic acid salt monomers (S-PAA), where the cation (S) can be a metal cation, and acrylamide monomers. Desirable polymer binders are found to have both good adhesion with respect to the current collector and good particle to particle cohesion. The S-PAA monomers can contribute good cohesion, and the acrylamide co-monomer can contribute good adhesion. Binders based on a copolymer of S-PAA and acrylamide can be provided with appropriate proportions of the monomers to result in excellent cycling with silicon based negative electrode active materials. Water-based polymer blends effective to achieve excellent cycling of silicon-based anodes are summarized below and are described further in published U.S. patent application 2022/0006090 to Hays et al. (hereinafter the '047 application), entitled “Lithium Ion Cells With Silicon Based Active Materials and Negative Electrodes with Water-Based Binders Having Good Adhesion and Cohesion,” incorporated herein by reference.

The simultaneous achievement of good adhesion and good cohesion is found to be significant for achieving improved cycling. The monomer units of the copolymer binder are an acrylamide and a salt of polyacrylic acid (S-PAA). The salt cation can be a metal cation, such as lithium (LiPAA) or sodium (NaPAA) or potassium (KPAA), although other metals can be used or non-metal cations, such as ammonium NH₄⁺. A mixture of counter ions can be used if desired. S-PAA polymers are found to contribute strong cohesion to the corresponding electrodes. Cohesion can be evaluated for the electrode structure on the current collector with bending around a mandrel with a particular diameter. Adhesion is evaluated using commercial testing equipment with forces applied in a controlled fashion to evaluate the forces to pull the electrode from the current collector. The ratio of monomer units can be selected to achieve a desired balance of adhesive and cohesive stability.

The copolymer can be synthesized following published methods. Specifically, the acrylate groups can be formed from a nucleophilic substitution of amide groups by carboxylate groups with the extent of the reaction controlling the degree of acrylamide groups in the final polymer. Alternatively, the copolymer can be formed directly through the polymerization reactions. With the direct synthesis the relative amounts of carboxylate groups and acrylamide groups can be controlled. Also, the molecular weight of the polymers can be appropriately controlled or selected.

The molar ratio of acrylamide moieties to S-PAA moieties can range from about 5:95 to about 95:5, in further embodiments from about 10:90 to about 90:10, in additional embodiments from about 20:80 to about 80:20, in other embodiments from about 25:75 to about 75:25, and in some embodiments from about 30:70 to about 70:30. With respect to average molecular weight, the copolymer can have in some embodiments an average molecular weight from about 50,000 Daltons to about 5,000,000 Daltons, in further embodiments from about 75,000 Daltons to about 2,000,000 Daltons, and in other embodiments from about 100,000 Daltons to about 1,000,000 Daltons. A person of ordinary skill in the art will recognize that additional ranges of moiety ratios and average molecular weight within the explicit ranges above are contemplated and are within the present disclosure.

While desirable cycling results have been achieved with the copolymers alone as the electrode binders, Applicant has had success in improving binder performance using polymer blends. The copolymers described herein may be useful also in polymer blends. Suitable polymer blends would generally include at least 25 weight percent poly(acrylamide-co-M-PAA), in further embodiments at least about 35 wt %, and in other embodiments from about 40 wt % to about 90 wt %. A person of ordinary skill in the art will recognize that additional ranges within the explicit polymer blend rations above are contemplated and are within the present disclosure. Commercial aqueous electrode binders are sold by Sumitomo Seika Chemicals Co., as Aquacharge®.

The active material loading in the binder can be large. In some embodiments, the negative electrode has from about 75 to about 94 wt % of negative electrode active material, in other embodiments from about 77 to about 93 wt % of the negative electrode active material, and in further embodiments from about 80 to about 92 wt % of the negative electrode active material. In some embodiments, the negative electrode has from about 4 to about 20 wt % polymeric binder, in other embodiments about 5 to 19 wt % polymeric binder, and in further embodiments from about 6 to 18 wt % polymeric binder. Also, in some embodiments, the negative electrode comprises from about 1 to about 7 wt % nanoscale conductive carbon, in further embodiments form about 1.5 to about 6.5 wt %, and in additional embodiments from about 2 to about 6 wt % nanoscale conductive carbon. A person of ordinary skill in the art will recognize that additional ranges of polymer loadings within the explicit ranges above are contemplated and are within the present disclosure.

For improved cycling negative electrodes, nanoscale conductive additives or combinations thereof, which are particulates, have been found to be particularly desirable. Nanoscale conductive carbon refers generally to particles of high surface area elemental carbon having at least two dimensions of the primary particles being submicron. Suitable nanoscale conductive carbon includes, for example, carbon black, carbon nanotubes and carbon nanofibers. In some embodiments, the nanoscale conductive carbon additive used in the negative electrode can comprise carbon nanotubes, carbon nanofibers, carbon nanoparticles (e.g., carbon black), or combinations thereof. Other nanoscale conductive additives include, for example, metal nanoparticles, metal nanofibers, metal nanowires, other metal nano-particulates, and combinations thereof, such as silver nanoparticles, silver nanowires and the like. In some embodiments, to achieve improved performance a conductive additive can have a conductivity of at least about 40 S/cm, in some embodiments at least about 50 S/cm, and in further embodiments at least about 60 S/cm. A person of ordinary skill in the art will recognize that additional ranges of particles loadings and conductivities within the explicit ranges about are contemplated and are within the present disclosure.

Electrical conductivity, which is the inverse of resistivity, can be reported by distributors, and the conductivity is generally measured using specific techniques developed by the distributors. For example, measurements of carbon black electrical resistance is performed between two copper electrodes with Super P™ carbon blacks, see Timcal Graphite & Carbon, A Synopsis of Analytical Procedures, 2008, www.timcal.com. Suitable supplemental electrically conductive additives can also be added to contribute to longer term cycling stability. Alternatively, some suppliers describe the conductive carbon concentrations to achieve the conductive percolation threshold.

Carbon black refers to synthetic carbon materials and can alternative be referred to as acetylene black, furnace black, thermal black or other names suggesting the synthesis approach. Carbon black generally is referred to as amorphous carbon, but there are suggestions of small domains with short or medium range order corresponding to graphite or diamond crystal structure in at least some forms of carbon black, but for practical purposes the material can be considered amorphous. Under ISO Technical Specification 80004-1 (2010) carbon black is a nanostructured material. The primary particles of carbon black can be on the order of tens of nanometers or less, but the primary particles are generally hard fused into chains or other aggregates, and the smallest dispersible units can be considered between about 80 nm and 800 nm, which is still submicron. Carbon blacks are available commercially that have been synthesized to provide a desirable level of electrical conductivity, such as Super-P® (Timcal), Ketjenblack® (Akzo Nobel), Shawinigan Black® (Chevron-Phillips), and Black Pearls 2000® (Cabot).

Carbon nanofibers are high aspect ratio fibers that generally comprise graphene layers in plates, cones or other forms, which carbon nanotubes comprise graphene sheets folded into tubes. Carbon nanofibers can have diameters of 250 nm or less and are commercially available, for example, Pyrograf® carbon nanofibers (Pyrograf Products, Inc.) or from American Elements, Inc. Carbon nanotubes have been found to be a desirable conductive additive that can improve cycling performance for either a positive electrode or a negative electrode. Single wall or multiwall carbon nanotubes are also available from American Elements, Inc. (CA, USA), Cnano Technologies (China), Fuji, Inc. (Japan), Alfa Aesar (MA, USA) or NanoLabs (MA, USA).

The negative electrode used in the cells described herein can have high active material loading levels along with reasonably high electrode density. For a particular active material loading level, the density is inversely correlated with thickness so that an electrode with a greater density is thinner than an electrode with a lower density. Loading is equal to the density times the thickness. In some embodiments, the negative electrode of the battery has a loading level of negative electrode active material that is at least about 1.5 mg/cm², in other embodiments from about 2 mg/cm² to about 8 mg/cm², in additional embodiments from about 2.5 mg/cm² to about 6 mg/cm², and in other embodiments from about 3 mg/cm² to about 5 mg/cm². In some embodiments, the negative electrode of the battery has an active material density in some embodiment from about 0.5 g/cc (cc=cubic centimeters (cm³)) to about 2 g/cc, in other embodiment from about 0.6 g/cc to about 1.5 g/cc, and in additional embodiments from about 0.7 g/cc to about 1.3 g/cc. Similarly, the silicon oxide based electrodes can have an average dried thickness of at least about 15 microns, in further embodiments at least about 20 microns and in additional embodiments from about 25 microns to about 75 microns. The resulting silicon oxide based electrodes can exhibit capacities per unit area of at least about 3.5 mAh/cm², in further embodiments at least about 4.5 mAh/cm² and in additional embodiments at least about 6 mAh/cm². A person of ordinary skill in the art will recognize that additional ranges of active material loading level and electrode densities within the explicit ranges above are contemplated and are within the present disclosure.

### High Capacity Silicon Based Anode Materials

In general, the battery designs herein are based on a high capacity anode active material. Specifically, the anode active materials generally have a specific capacity of at least about 800 mAh/g, in further embodiments at least about 900 mAh/g, in additional embodiments at least about 1000 mAh/g, in some embodiments at least about 1150 mAh/g and in other embodiments at least about 1400 mAh/g when cycled at a rate of C/10 against lithium metal from 0.005V to 1.5V. As this implies, the specific capacity of negative electrode active material can be evaluated in a cell with a lithium metal counter electrode. However, in the batteries described herein, the negative electrodes can exhibit reasonably comparable specific capacities when cycled against high capacity lithium metal oxide positive electrode active materials. In the battery with non-lithium metal electrodes, the specific capacity of the respective electrodes can be evaluated by dividing the battery capacity by the respective weights of the active materials. As described herein, desirable cycling results can be obtained with a combination of a silicon based active material and a graphitic carbon active material with good capacities observed.

Elemental silicon, silicon alloys, silicon composites and the like can have a low potential relative to lithium metal similar to graphite. However, elemental silicon generally undergoes a very large volume change upon alloying with lithium. A large volume expansion on the order of two to four times of the original volume or greater has been observed, and the large volume changes have been correlated with a significant decrease in the cycling stability of batteries having silicon-based negative electrodes.

Commercially available composites of silicon suboxide, elemental silicon and carbon can be used in the cells described herein. Also, other formulations of silicon based negative electrode active materials have been developed with high capacity and reasonable cycling properties. Some silicon based compositions are described below that provide potential and promising alternatives to commercially available SiO based compositions. The improved electrolyte formulations described herein are found to be particularly effective with silicon based negative electrode active materials as well as with blends of silicon based active materials with graphite.

Also, silicon based high capacity materials in a negative electrode of a lithium-based battery can exhibit in some formulations a large irreversible capacity loss (IRCL) in the first charge/discharge cycle of the battery. The high IRCL of a silicon-based anode can consume a significant portion of the capacity available for the battery's energy output. Since the cathode, i.e., positive electrode, supplies all of the lithium in a traditional lithium ion battery, a high IRCL in the anode, i.e., negative electrode, can result in a low energy battery. In order to compensate for the large anode IRCL, supplemental lithium can be added directly or indirectly to the negative electrode material to offset the IRCL. The use of supplemental lithium to improve the performance of silicon based electrodes is described also in the '694 patent and '228 patent, both cited above and incorporated herein by reference. The use of supplemental lithium in the improved battery designs is described further below.

The anode, i.e., negative electrode, of the batteries described herein can use nanostructured active silicon based materials to accommodate better for volume expansion and thus maintain the mechanical electrode stability and cycle life of the battery. Nanostructured silicon based negative electrode compositions are disclosed in the '694 application, the '228 patent, as well as U.S. Pat. No. 9,139,441 to Anguchamy et al. (the '441 patent), entitled: “Porous Silicon Based Anode Material Formed Using Metal Reduction,” incorporated herein by reference. Suitable nanostructured silicon can include, for example, nanoporous silicon and nanoparticulate silicon. Also, nanostructured silicon can be formed into composites with carbon and/or alloys with other metal elements. The objective for the design of improved silicon-based materials is to further stabilize the negative electrode materials over cycling while maintaining a high specific capacity and in some embodiments reducing the irreversible capacity loss in the first charge and discharge cycle. Furthermore, pyrolytic carbon coatings are also observed to stabilize silicon-based materials with respect to battery performance.

Desirable high capacity negative electrode active materials can comprise porous silicon (pSi) based materials and/or composites of the porous silicon based materials. In general, the pSi based material comprises highly porous crystalline silicon that can provide high surface areas and/or high void volume relative to bulk silicon. While nanostructured porous silicon can be formed through a variety of approaches such as electrochemical etching of a silicon wafer, particularly good battery performance has been obtained from nanostructured porous silicon obtained by metal reduction of silicon oxide powders. In particular, the material has particularly good cycling properties while maintaining a high specific capacity. The formation of composites of pSi based material with carbon based material or metal can additionally mechanically stabilize the negative electrode for improved cycling. Additional description of the pSi based material from the reduction of silicon oxide can be found in the '441 patent referenced above.

With respect to the composite materials, nanostructured silicon components can be combined with, for example, carbon nanoparticles and/or carbon nanofibers within an intimate composite material. The components can be, for example, milled to form the composite, in which the materials are intimately associated. Generally, it is believed that the association has a mechanical characteristic, such as the softer silicon coated over or mechanically affixed with the harder carbon materials. In additional or alternative embodiments, the silicon can be milled with metal powders to form alloys, which may have a corresponding nanostructure. The carbon components can be combined with the silicon-metal alloys to form multi-component composites.

Also, carbon coatings can be applied over the silicon-based materials to improve electrical conductivity, and the carbon coatings seem to also stabilize the silicon based material with respect to improving cycling and decreasing irreversible capacity loss. Desirable carbon coatings can be formed by pyrolyzing organic compositions. The organic compositions can be pyrolyzed at relatively high temperatures, e.g., from about 800° C. to about 900° C., to form a hard amorphous coating. In some embodiments, the desired organic compositions can be dissolved in a suitable solvent, such as water and/or volatile organic solvents for combining with the silicon based component. The dispersion can be well mixed with silicon-based composition. After drying the mixture to remove the solvent, the dried mixture with the silicon based material coated with the carbon precursor can be heated in an oxygen free atmosphere to pyrolyze the organic composition, such as organic polymers, some lower molecular solid organic compositions and the like, and to form a carbon coating.

As with silicon, oxygen deficient silicon oxide, e.g., silicon oxide, SiOₓ, 0.1≤x≤1.9, can intercalate/alloy with lithium such that the oxygen deficient silicon oxide can perform as an active material in a lithium ion battery. These oxygen deficient silicon oxide materials are generally referred to as silicon oxide based materials and in some embodiments can contain various amounts of silicon, silicon oxide, and silicon dioxide. The oxygen deficient silicon oxide can incorporate a relatively large amount of lithium such that the material can exhibit a large specific capacity. However, silicon oxide is observed generally to have a capacity that fades quickly with battery cycling, as is observed with elemental silicon.

Silicon oxide based compositions have been formed into composite materials with high capacities and very good cycling properties as described in the '228 patent referenced above. In particular, oxygen deficient silicon oxides can be formed into composites with electrically conductive materials, such as conductive carbons or metal powders, which surprisingly significantly improve cycling while providing for high values of specific capacity. Furthermore, the milling of the silicon oxides into smaller particles, such as submicron structured materials, can further improve the performance of the materials.

In general, a range of composites can be used and can comprise silicon oxide, carbon components, such as graphitic particles (Gr), inert metal powders (M), elemental silicon (Si), especially nanoparticles, pyrolytic carbon coatings (HC), carbon nano fibers (CNF), or combinations thereof. The component structure may or may not correspond with the structure of the components within the composite material. Thus, the general compositions of the composites can be represented as αSiO-βGr-χHC-δM-εCNF-ϕSi, where α, β, χ, δ, ε, and ϕ are relative weights that can be selected such that a α+β+χ+δ+ε+ϕ=1. Generally 0.35<α<1, 0≤β<0.6, 0≤χ<0.65, 0≤δ<0.65, 0≤ε<0.65, and 0≤ϕ<0.65. Certain subsets of these composite ranges are of particular interest. In some embodiments, composites with SiO and one or more carbon based components are desirable, which can be represented by a formula αSiO-βGr-χHC-εNF, where 0.35<α<0.9, 0≤β<0.6, 0≤χ<0.65 and 0≤ε<0.65 (δ=0 and ϕ=0), in further embodiments 0.35<α<0.8, 0.1≤β<0.6, 0.0≤χ<0.55 and 0≤ε<0.55, in some embodiments 0.35<α<0.8, 0≤β<0.45, 0.0≤χ<0.55 and 0.1≤ε<0.65, and in additional embodiments 0.35<α<0.8, 0≤β<0.55, 0.1≤χ<0.65 and 0≤ε<0.55. In additional or alternative embodiments, composites with SiO, inert metal powders and optionally one or more conductive carbon components can be formed that can be represented by the formula αSiO-βGr-χHC-δM-εCNF, where 0.35<α1.0≤β<0.55, 0≤χ<0.55, 0.1≤δ<0.65, and 0≤ε<0.55. In further additional or alternative embodiments, composites of SiO with elemental silicon and optionally one or more conductive carbon components can be formed that can be represented by the formula αSiO-βGr-χHC-εCNF-ϕSi, where 0.35<α<1, 0≤β<0.55, 0≤χ<0.55, 0≤ε<0.55, and 0.1≤ϕ<0.65 and in further embodiments 0.35<α<1, 0≤β<0.45, 0.1≤χ<0.55, 0≤ε<0.45, and 0.1≤ϕ<0.55. A person or ordinary skill in the art will recognize that additional ranges within the explicit ranges above are contemplated and are within the present disclosure. As used herein, the reference to composites implies application of significant combining forces, such as from HEMM milling, to intimately associate the materials, in contrast with simple blending, which is not considered to form composites.

Solution based approaches for the synthesis of various Si—SiOₓ—C—M (M=metal) composites are described in U.S. patent application to Han et al., entitled “Silicon-Based Active Materials for Lithium Ion Batteries and Synthesis With Solution Processing,” incorporated herein by reference. Silicon-based carbon composites with graphene sheets are described in U.S. Pat. No. 10,886,526 to Anguchamy et al., entitled “Silicon-Silicon Oxide-Carbon Composites For Lithium Battery Electrodes and Methods for Forming the Composites,” incorporated herein by reference. Commercial materials that are believed to comprise a SiOₓ—Si—C or SiOₓ—Si composite are used in the batteries in the Examples.

### Positive Electrodes

Various positive electrode chemistries can be introduced effectively with the improved negative electrodes described above. The selected compositions can be blended into positive electrode along with a suitable binder and electrically conductive materials. This section focuses on particularly desirable positive electrode active materials for high voltage cycling and moderately high capacity. Also, this section describes the overall electrode composition and properties.

To some degree, the desired application of the final cells can influence the selection of the positive electrode composition. From this perspective, a broad range of compositions are described in the following. For automotive use and for similar applications, a particular positive electrode chemistry has found to be desirable with respect to achieving high energy density along with cycling to over 600 cycles while maintaining at least 80% capacity. Specifically, nickel-rich lithium nickel manganese cobalt oxides are found to provide the long cycling performance herein based on the improved electrolytes described herein. In alternative embodiments, a blend of nickel-rich lithium nickel manganese cobalt oxide and (lithium+manganese) rich-lithium nickel manganese cobalt oxide are blended to provide reasonable positive electrode performance. Furthermore, the nickel rich lithium nickel manganese cobalt oxides alone as the active material can provide desirably high energy densities due to the average discharge voltage with good cycling when paired with the silicon based negative electrodes described herein. Examples are presented below for a nickel rich lithium nickel manganese cobalt oxides alone.

Nickel-rich lithium nickel manganese cobalt oxides (N-NMC) can provide desirable cycling and capacity properties for the lithium ion batteries described herein. In particular, the nickel-rich compositions can be approximately represented by the formula LiNiₓMn_{y}Co_{z}O₂, x+y+z≈0.45≤x, 0.025≤y, z≤0.35, in further embodiments, 0.50≤x, 0.03≤y, z≤0.325, and in 0.55≤x, 0.04≤y, z≤0.3. Note in the art, NMC and NCM are used interchangeably. The amount of nickel can influence the selected charge voltage to balance cycling stability and discharge energy density. For values of x in the range of 0.525≤x≤0.7 a selected charge voltage can be from 4.25V to 4.375V. For values of x in the range of 0.7≤x≤0.9, the selected charge voltage can be from 4.05V to 4.325V. Examples are provided with NMC 811 (x=0.8, y=z =0.1) or NMC 622 (x=0.6, y=z=0.2) with a charge voltage of 4.2V. A person of ordinary skill in the art will recognize that additional ranges of composition and selected charge voltages within the explicit ranges above are contemplated and are within the present disclosure. These compositions have been found to provide relatively stable higher voltage cycling, good capacities and desirable impedance. N-NMC powders can be synthesized using techniques, such as coprecipitation described further below, and these are available commercially, such as from BASF (Germany), TODA (Japan), L&F Materials Corp. (Korea), Unicore (Belgium), and Jinhe Materials Corp. (China). Commercially available formulations of these compounds include, for example, LiNi_{0.5}Mn_{0.3}Co_{0.2}O₂ (BASF), LiNi_{0.6}Mn_{0.2}Co_{0.2}O₂ (L&F, Korea and Umicore, Belgium), LiNi_{0.8}Mn_{0.1}Co_{0.1}O₂ (L&F, Korea, BASF, Germany, Umicore, Belgium and LG Chemical, Korea).

For the N-NMC compositions, the average voltage trends slightly larger with increasing amounts of nickel, but the charge voltage for stable cycling trends slightly lower with increasing nickel. Thus, there can be tradeoffs with active material selection, although the N-NMC active materials can provide good cycling and reasonably high capacity and energy density.

For the N-NMC compositions, the average voltage trends slightly larger with increasing amounts of nickel, but the charge voltage for stable cycling trends slightly lower with increasing nickel. Thus, there can be tradeoffs with active material selection, although the N-NMC active materials can provide good cycling and reasonably high capacity and energy density.

As noted above, desirable blends can comprise N-NMC with (lithium rich+manganese rich) lithium nickel manganese cobalt oxides (LM-NMC or HCMR®). These compositions can be approximately represented by the formula Li_{1+b}Ni_{α}Mn_{β}Co_{γ}A_{δ}O_{2-z}F_{z}, where b+α+β+γ+δ≈1, b ranges from about 0.04 to about 0.3, α ranges from 0 to about 0.4, β range from about 0.2 to about 0.65, γ ranges from 0 to about 0.46, δ ranges from about 0 to about 0.15 and z ranges from 0 to 0.2, with the proviso that both α and γ are not 0, and where A is a metal different from lithium, manganese, nickel and cobalt. In some embodiments, A can be Mg, Sr, Ba, Cd, Zn, Al, Ga, B, Zr, Ti, Ca, Ce, Y, Nb, Cr, Fe, V, or combinations thereof. Also, in additional or alternative embodiments, Li_{1+b}Ni_{α}Mn_{β}Co_{γ}A_{δ}O₂ with 0.05≤b≤0.125, 0.225≤α≤0.35, 0.35≤β≤0.45, 0.15≤γ≤0.3, 0≤δ≤0.05 and up to five mole percent of the oxygen can be replaced with a fluorine dopant. A person of ordinary skill in the art will recognize that additional ranges of composition within the explicit ranges above are contemplated and are within the present disclosure. Long cycle stability has been achieved for (lithium+manganese) rich-NMC active materials at relatively high cycling voltages, as described in U.S. Pat. No. 8,928,286 to Amiruddin et al., entitled “Very Long Cycling of Lithium Batteries With Lithium Rich Cathode Materials,” incorporated herein by reference.

The LM-NMC positive electrode material can be advantageously synthesized by co-precipitation and sol-gel processes. In some embodiments, the positive electrode material is synthesized by precipitating a mixed metal hydroxide or carbonate composition from a solution comprising +2 cations wherein the hydroxide or carbonate composition has a selected composition. The metal hydroxide or carbonate precipitates are then subjected to one or more heat treatments to form a crystalline layered lithium metal oxide composition.

It is found that for LM-NMC positive electrode active materials a coating on the material can improve the performance of corresponding cells. Suitable coating materials, which are generally believed to be electrochemically inert during battery cycling, can comprise metal fluorides, metal oxides, or metal non-fluoride halides. It is found that for LM-NMC positive electrode active materials a coating on the material can improve the performance of corresponding cells. Suitable coating materials, which are generally believed to be electrochemically inert during battery cycling, can comprise metal fluorides, metal oxides, or metal non-fluoride halides. Improved metal fluoride coatings with appropriately engineered thicknesses are described in U.S. Pat. No. 9,843,041 to Lopez et al, entitled “Coated Positive Electrode Materials for Lithium Ion Batteries,” incorporated herein by reference.

The positive electrode active materials can optionally comprise from 0 to 25 weight percent additional active materials, such as lithium cobalt oxide, LiNi_{0.33}Mn_{0.33}Co_{0.33}O₂ (NMC111), LiNi_{0.8}Co_{0.15}AL_{0.05}O₂ (NCA), mixtures thereof, or the like. A person of ordinary skill in the art will recognize that additional ranges of composition blends within the explicit ranges above are contemplated and are within the present disclosure.

As noted above, the positive electrode generally comprises active material, with an electrically conductive material within a binder. The active material loading in the electrode can be large. In some embodiments, the positive electrode comprises from about 85 to about 99% of positive electrode active material, in other embodiments from about 90 to about 98% of the positive electrode active material, and in further embodiments from about 95 to about 97.5% of the positive electrode active material. In some embodiments, the positive electrode has from about 0.75 to about 10% polymeric binder, in other embodiments from about 0.8 to about 7.5% polymeric binder, and in further embodiments from about 0.9 to about 5% polymeric binder. The positive electrode composition generally can also comprise an electrically conductive additive distinct from the electroactive composition. Suitable nanoscale conductive particulates are described above in the context of the negative electrode, and these can similarly be used in the positive electrode. In some embodiments, the positive electrode can have 0.4 weight percent to about 12 weight percent conductive additive, in further embodiments from about 0.45 weight percent to about 7 weight percent, and in other embodiments from about 0.5 weight percent to about 5 weight percent conductive additive. A person of ordinary skill in the art will recognize that additional ranges of particles loadings within the explicit ranges about are contemplated and are within the present disclosure. The positive electrode active materials are described above. Suitable polymer binders for the positive electrode include, for example, PVDF, PEO, polyimide, polyethylene, polypropylene, polytetrafluoroethylene, polyacrylates, rubbers, e.g. ethylene-propylene-diene monomer (EPDM) rubber or SBR, copolymers thereof, or mixtures thereof. For the positive electrode, PVDF can be used with good results, and the positive electrodes in the examples use a PVDF binder. Water based binders, as described above, can also be used for the positive electrode. Electrically conductive additives are described in detail for the negative electrode, and nanoscale conductive carbon can be used effectively for the positive electrode.

For a particular loading level, the electrode density (of active material) is inversely correlated with thickness so that an electrode with a greater density is thinner than an electrode with a lower density. Loading is equal to the density times the thickness. In some embodiments, the positive electrode of the battery has a loading level of positive electrode active material that is from about 10 to about 40 mg/cm², in other embodiments from about 12 to about 37.5 mg/cm², in additional embodiments from about 13 to about 35 mg/cm², and in other embodiments from 20 to about 32.5 mg/cm² In some embodiments, the positive electrode of the battery has an active material density in some embodiment from about 2.5 g/cc to about 4.6 g/cc, in other embodiment from about 3.0 g/cc to 4.4 g/cc, and in additional embodiment from about 3.25 g/cc to about 4.3 g/cc. In further embodiments, the positive electrodes can have a thickness on each side of the current collector following compression and drying of the positive electrode material from about 45 microns to about 300 microns, in some embodiments from about 80 microns to about 275 microns and in additional embodiments from about 90 microns to about 250 microns. A person of ordinary skill in the art will recognize that additional ranges of active material loading level, electrode thickness and electrode densities within the explicit ranges above are contemplated and are within the present disclosure.

### Supplemental Lithium

The improved high energy battery designs described herein generally comprise supplemental lithium, and this section is directed to approaches for the incorporation of supplemental lithium for appropriate embodiments. In general, the inclusion of supplemental lithium is desirable for cells with silicon-based negative electrode active materials since the material may exhibit relatively high irreversible capacity loss during the initial charge of the battery. Also, supplemental lithium surprisingly also stabilizes cycling of LM-NMC. Various approaches can be used for the introduction of supplemental lithium into the battery, although following corresponding initial reactions and/or charging, the negative electrode becomes associated with excess lithium for cycling from the supplemental lithium. With respect to the negative electrode in batteries having supplemental lithium, the structure and/or composition of the negative electrode can change relative to its initial structure and composition following the first cycle as well as following additional cycling. Generally, the positive electrodes are provided with extractable lithium, and initiation or formation of the cell involves an initial charge to extract the lithium from the positive electrode, which is generally greater than or equal the cycling capacity. Supplemental lithium can be considered supplemental to the initial lithium provided in the positive electrode active material.

Depending on the approach for the introduction of the supplemental lithium, the positive electrode may initially comprise a source of supplemental lithium and/or a sacrificial electrode can be introduced comprising supplemental lithium. Additionally or alternatively, supplemental lithium can be associated with the negative electrode. In some embodiments, the supplemental lithium can be introduced into the negative electrode using electrochemical methods in contrast with purely chemical or mechanical methods. If the supplemental lithium is initially located in the positive electrode or a separate electrode, the negative electrode can be an unaltered form with no lithium present until the battery is charged or at least until the circuit is closed between the negative electrode and the electrode with the supplemental lithium in the presence of electrolyte and a separator. For example, the positive electrode or supplemental electrode can comprise elemental lithium, lithium alloy and/or other sacrificial lithium source in addition to other electrode components.

If sacrificial lithium is included in the positive electrode, the lithium from the sacrificial lithium source is loaded into the negative electrode during the charge reaction. The voltage during the charging based on the sacrificial lithium source may be significantly different than the voltage when the charging is performed based on the positive electrode active material. For example, elemental lithium in the positive electrode can charge the negative electrode active material without application of an external voltage since oxidation of the elemental lithium can drive the reaction as long as the circuit is closed. For some sacrificial lithium source materials, an external voltage is applied to oxidize the sacrificial lithium source in the positive electrode and drive lithium into the negative electrode active material. The charging generally can be performed using a constant current, a stepwise constant voltage charge or other convenient charging scheme. However, at the end of the charging process, the battery should be charged to a desired voltage, which then also involves extraction of lithium (e.g., de-intercalation or de-alloying) from the positive electrode active material.

In some embodiments, at least a portion of the supplemental lithium is initially associated with the negative electrode. For example, the supplemental lithium can be in the form of elemental lithium, a lithium alloy or other lithium source that is more electronegative than the negative electrode active material. Elemental lithium can be in the form of a thin film, such as formed by evaporation, sputtering or ablation, a lithium or lithium alloy foil and/or a powder. Elemental lithium, especially in powder form or dispersed power in non-aqueous solvent, can be coated to stabilize the lithium for handling purposes, and commercial lithium powder dispersions are available from Livent Corporation are sold with proprietary coatings for stability. The coatings generally do not alter the performance of the lithium powders for electrochemical applications. After the negative electrode is in contact with electrolyte, a reaction can take place, and the supplemental lithium is transferred to the negative electrode active material. Since the electrode is electrically conductive internally, the circuit does not need to be closed to provide for electron flow resulting from the reactions. During this process, the solid electrolyte interface (SEI) layer may also be formed, at least partially. Thus, the supplemental lithium is loaded into the negative electrode active material with at least a portion generally consumed in formation of the SEI layer. Supplemental lithium placed into the negative electrode should be more electronegative than the active material in the negative electrode since there is no way of reacting the supplemental lithium source with the active material in the same electrode through the application of a voltage.

In some embodiments, supplemental lithium associated with the negative electrode can be incorporated as a powder within the negative electrode. Specifically, the negative electrode can comprise an active negative electrode composition and a supplemental lithium source within a polymer binder matrix, and any electrically conductive powder if present. A supplemental lithium source layer can comprise a foil sheet of lithium or lithium alloy, supplemental lithium powder within a polymer binder and/or particles of supplemental lithium source material placed on the surface of the active layer. In an alternative configuration, a supplemental lithium source layer is between the active layer and current collector. Also, in some embodiments, the negative electrode can comprise supplemental lithium source layers on both surfaces of the active layer.

An arrangement to perform electrochemical preloading of lithium can comprise an electrode with silicon-based active material formed on a current collector, which are placed in vessel containing electrolyte and a sheet of lithium source material contacting the electrode. The sheet of lithium source material can comprise lithium foil, lithium alloy foil or a lithium source material in a polymer binder optionally along with an electrically conductive powder, which is in direct contact with the negative electrode to be preloaded with lithium such that electrons can flow between the materials to maintain electrical neutrality while the respective reactions take place. In the ensuing reaction, lithium is loaded into the silicon based active material through intercalation, alloying or the like. In alternative or additional embodiments, the negative electrode active material can be mixed in the electrolyte and the lithium source material for incorporation of the supplemental lithium prior to formation into an electrode with a polymer binder so that the respective materials can react in the electrolyte spontaneously. In some embodiments, a lithium source within an electrode can be assembled into a cell with the electrode to be preloaded with lithium. A separator can be placed between the respective electrodes. Current can be allowed to flow between the electrodes to provide for controlled electrochemical prelithiation.

In some embodiments, a lithium source within an electrode can be assembled into a cell with the electrode to be preloaded with lithium. A separator can be placed between the respective electrodes. Current can be allowed to flow between the electrodes to provide for controlled electrochemical prelithiation. Depending on the composition of the lithium source it may or may not be necessary to apply a voltage to drive the lithium deposition within the silicon-based active material. An apparatus to perform this lithiation process can comprise a container holding electrolyte and a cell, which comprises an electrode, to be used as a negative electrode in an ultimate battery, a current collector, a separator and a sacrificial electrode that comprises the lithium source, such as lithium metal foil, where the separator is between the sacrificial electrode and the electrode with the silicon-based active material. A convenient sacrificial electrode can comprise lithium foil, lithium powder embedded in a polymer or lithium alloys, although any electrode with extractable lithium can be used. The container for the lithiation cell can comprise a conventional battery housing, a beaker, or any other convenient structure. This configuration provides the advantage of being able to measure the current flow to meter the degree of lithiation of the negative electrode. Furthermore, the negative electrode can be cycled once or more than once in which the negative electrode active material is loaded close to full loading with lithium. In this way, an SEI layer can be formed with a desired degree of control during the preloading with lithium of the negative electrode active material. Then, the negative electrode is fully formed during the preparation of the negative electrode with a selected preloading with lithium.

In alternative or additional embodiments, the negative electrode active material can be mixed in the electrolyte and the lithium source material for incorporation of the supplemental lithium prior to formation into an electrode with a polymer binder so that the respective materials can react in the electrolyte spontaneously. Commercial SiO-Si-C composite compositions are presently commercially available such as from Shin-Etsu Chemical Company, Japan, KSC-series products. The various approaches for incorporating supplemental lithium into a cell is described in U.S. Pat. No. 9,166,222 to Amiruddin et al., entitled “Lithium Ion Batteries With Supplemental Lithium,” incorporated herein by reference.

In general, for embodiments in which supplemental lithium is used, the amount of supplemental lithium preloaded or available to load into the active composition can be in an amount of at least about 2.5% of capacity, in further embodiments from about 3 percent to about 55 percent of capacity, in additional embodiments from about 5 percent to about 52.5 percent of capacity, and in some embodiments from about 5 percent to about 50 percent of the negative electrode active material capacity. The supplemental lithium can be selected to approximately balance the IRCL of the negative electrode, although other amounts of supplemental lithium can be used as desired. In some embodiment, the supplemental lithium added is in an amount with an oxidation capacity corresponding to from 60% to 180% of the first cycle IRCL of the negative electrode, in further embodiments, it is from 80% to 165%, and in other embodiments from 90% to 155%. A person of ordinary skill in the art will recognize that additional ranges of percentage within the explicit ranges above are contemplated and are within the present disclosure. Thus, the contribution to the IRCL of the negative electrode can be effectively reduced or removed due to the addition of the supplemental lithium such that the measured IRCL of the battery represents partially or mostly contributions from the IRCL of the positive electrode, which is not diminished due to the presence of supplemental lithium. A person of ordinary skill in the art will recognize that additional ranges of IRCL within the explicit ranges above are contemplated and are within the present disclosure.

### Balance of Cathode and Anode

The overall performance of the battery has been found to depend on the capacities of both the negative electrode and positive electrode and their relative balance. Balance of the electrodes has been found to be significant with respect to achieving a particularly high energy density for the battery as well as to achieve good cycling properties. In some embodiments, there may be a tradeoff with respect to achieving longer cycling stability and energy density. To achieve longer cycling stability, it can be desirable to balance the battery to achieve a relatively lower energy density, but with a battery suitable for stable long term use under a broader range of operating parameters. With appropriately selected active materials, desirable electrode designs and improved electrolyte formulations, high energy densities are still achievable while obtaining cycling to more than 800 cycles with no more than 80% capacity drop. The electrode balance can be evaluated in several alternative ways, which can work effectively when properly accounting for the particular evaluation approach.

Testing of active materials can be performed in lithium cells with a lithium metal electrode, and such cells are generally referred to as half-cells, in contrast with lithium ion cells with both electrodes comprising a lithium alloying or intercalation material (referred to as full cells). In a half cell with a silicon based electrode, the lithium electrode acts as the negative electrode, and the silicon based electrode acts as the positive electrode, which is opposite of its usual role as the negative electrode in a lithium ion cell.

The positive electrode active material capacity can be estimated from the capacity of the material which can be measured by cycling the material against lithium metal foil. For example, for a given positive electrode, the capacity can be evaluated by determining the insertion and extraction capacities during the first charge/discharge cycle, where the lithium is de-intercalated or extracted from the positive electrode to a voltage selected based on the material chemistry and the selected charge voltage of the cell design (generally from 4.2V to 4.5V) and intercalated or inserted back into the positive electrode to 2V at a rate of C/20, with a slight adjustment, e.g. generally 0.1V, to a higher charge voltage against the lithium metal based on the voltage of the ultimate anode relative to lithium metal. For a positive electrode active material, the selection of the charge voltage sets the capacity of the cell and can be selected for a particular material, in part, to facilitate a particular cycling stability, voltage profile over a cycle, and impedance over a cycle.

Similarly, for a given silicon based electrode, the insertion and extraction capacities can be evaluated with a battery having a positive electrode comprising the silicon based active material and a lithium foil negative electrode. The capacity is evaluated by determining the insertion and extraction capacities of the battery during the first charge/discharge cycle where lithium is intercalated/alloyed to the silicon based electrode to 5 mV and de-intercalated/de-alloyed to 1.5V at a rate of C/20.

In actual use, the observed capacities can change from the tested capacities due to various factors, such as high rate operation and alteration of voltage range, which can be due to battery design as well as due to composition of the counter electrode not being lithium metal. For some evaluation approaches, a subsequent capacity after the first cycle can be used to evaluate electrode balance, and if desired a greater discharge rate can be used, such as C/3 or C/10. The use of the balance after a formation cycle or a few formation cycles can be desirable in that the balance is based more on conditions during use of the battery.

In most commercially available carbon based batteries, approximately 5-10% excess anode is taken over the cathode to prevent lithium plating. One important concern of too much excess anode is that the weight of the cell will increase reducing the energy density of the cell. Compared to graphite which has a first cycle IRCL of ˜7%, high capacity silicon based anodes can have IRCL ranging from about 10% to about 40%. A significant portion of the capacity may become inactive in the cell after the first charge-discharge cycle and add to significant dead weight to the battery.

For high capacity anode materials, the negative electrode irreversible capacity loss generally is greater than the positive electrode irreversible capacity loss, which generates additional lithium availability for the cell. If the negative electrode has a significantly higher irreversible capacity loss than the positive electrode, the initial charge of the negative electrode irreversibly consumes lithium so that upon subsequent discharge, the negative electrode cannot supply enough lithium to provide the positive electrode with sufficient lithium to satisfy the full lithium accepting capacity of the positive electrode. This results in a waste of positive electrode capacity, which correspondingly adds weight that does not contribute to cycling. Most or all of the lithium loss from the net IRCL (negative electrode IRCL minus positive electrode IRCL) can be compensated by supplemental lithium as described above. Evaluation of electrode balance during the 1st formation cycle may or may not account for supplemental lithium. In subsequent cycles after the formation cycle or a few cycles, any excess supplemental lithium not consumed for the IRCL is generally alloyed into the anode material. The electrode balance can be evaluated at a cycling stage after formation, such as the 4th cycle at a selected rate, and these capacities can be estimated from the electrode performances.

From the perspective of providing stable longer term cycling performance, it can be desirable to balance the electrodes to provide for effective use of both electrode capacities as well as avoiding the plating of lithium metal during cycling. In general, the balance of the electrodes is considered at the time of assembly of the electrodes referencing the initial capacities of the electrodes relative to lithium metal.

In general, battery life can be selected to end when the energy output drops by roughly 20% from the initial capacity at a constant discharge rate, although other values can be selected as desired. For the materials described herein, the drop in capacity with cycling of the negative electrode is generally greater than for the positive electrode, so that the avoidance of lithium metal deposition with cycling suggests a greater excess capacity of the negative electrode to further stabilize cycling. Roughly, if the negative electrode capacity fades about twice as fast as the positive electrode capacity, it would be desirable to include at least 10% additional negative electrode capacity to account for cycling. In the robust battery design, at least about 10% additional negative electrode can be desired at various discharge conditions. In general, the balance can be selected such that the initial negative electrode charge capacity evaluated at a rate of C/20 from an open circuit voltage to 1.5V against lithium is about 110% to about 195%, in further embodiment from about 120% to about 185% and in additional embodiments from about 130% to about 190% relative to the sum of the initial positive electrode charge capacity at a rate of C/20 from an open circuit voltage to the charge voltage of the cell design (generally from 4.2V to 4.6V) plus the oxidation capacity of any supplemental lithium. Alternatively, the electrode balance can be evaluated at the fourth cycle at a discharge rate of C/10 or C/3 with the negative electrode capacity relative to positive electrode capacity from about 110% to about 195%, in further embodiment from about 120% to about 185% and in additional embodiments from about 130% to about 190%. A person of ordinary skill in the art will recognize that additional ranges of balance within the explicit ranges above are contemplated and are within the present disclosure. Such a balance is described in the battery designs described below.

### Cell Performance

### Cell Performance Properties

The combination of design features with the described electrolytes can provide longer cycling stability while maintaining desired high power cell performance. In particular applications, it can be significant to maintain the power capability later in the cell life prior to charging. In other words, the cell should have high rate capability and high capacity, while maintaining cycle life to be a practical solution. The achievement of the long term high power cycling involves use of the improved electrolytes described above along with the balance of cell design parameters, especially for the negative electrode. The selected charge voltage can be influenced by the positive electrode active material. The cells can exhibit a high capacity at a fast discharge rate. In some embodiments, the specific capacity for discharge from a selected charge voltage to 2.5V at room temperature can be at least about 135 mAh/g based on positive electrode active weight at a 5 C discharge rate.

Generally, the selected charge voltage for these cells is from about 4.05V to 4.4V. As noted above, a selected charge voltage is generally based on the cathode active materials since the anode is designed to have a low voltage against elemental lithium over the relevant voltage range. The cells can exhibit very good cycling performance with high power generation, which involves a high discharge rate. In some embodiments, the cells can exhibit a discharge capacity at cycle 700 of at least about 75% of the 6th cycle capacity discharged at a 4C rate from the selected charge voltage to 2.5V at room temperature, in other embodiments at least about 80% and in additional embodiments at least about 82% at the 700th cycle relative to the 6th cycle discharge capacity when cycled from the selected charge voltage to 2.5V at 1 C charge rate at room temperature. Similarly, the batteries can exhibit a discharge capacity at cycle 825 of at least about 75% of the 6th cycle capacity discharged at 1 C rate from the selected charge voltage to 2.5V at room temperature, in other embodiments at least about 80% and in additional embodiments at least about 82.5% at the 825th cycle relative to the 6th cycle discharge capacity when cycled from the selected charge voltage to 2.5V at a rate of 1 C rate at room temperature. A person of ordinary skill in the art will recognize that additional ranges within the explicit ranges above are contemplated and are within the present disclosure.

Power capability can be tested as a function of state of charge of the cell. The cell can be discharged at a rate of 1 C. Then, at every decrease of 10% state of charge, a 30 second 5 C discharge pulse can be applied to the cell. The power is calculated as the voltage times the current, and the current is evaluated as the voltage divided by the resistance (R). The evaluation is summarized in Eq. (1) and (2) below. Based on the power exhibited during the 30 second pulse, the power of the cell can be reported as a kW/kg. The available power then can be evaluated as a function of voltage at the state of charge at which the pulse is delivered. At a 70% state of charge, the cells can exhibit more than about 2 kW/kg.

R_{dischg pulse}=ΔV/ΔI=(Vt0−Vt1)/(It0−It1) (1)

Discharge pulse power capability=Vmin×(OCVₚᵤₗₛₑ−Vmin)/R_{dischg pulse} (2)

### EXAMPLES

General Methods and Materials. General methods and materials are described in the '047 and '925 patents cited above. The electrolyte formulations were tested through their incorporation into coin cells and pouch cells using NMC positive electrodes and negative electrodes incorporating a blend of silicon oxide based composites and graphite as the active materials.

The active materials for the positive electrodes were commercial lithium nickel manganese cobalt oxides having the formula LiNi_{0.6}Mn_{0.2}Co_{0.2}O₂ (NMC622) or LiNi_{0.8}Mn_{0.1}Co_{0.1}O₂ (NMC811). NMC811 is commercially available from different suppliers as a polycrystalline form or a single crystalline form, different examples are performed with each of these as the active material for the positive electrode. The positive electrodes had a loading of active material from about 93 wt % to 97.5 wt % blended with 1 wt % to 4 wt % PVDF binder, and 1 wt % to 3 wt % nanoscale carbon. The cathode material was blended with NMP solvent, spread onto an aluminum foil current collector, pressed, and dried.

The negative electrode active material was a commercial SiO—Si—C (SiOx) composite that was blended with electrochemically active graphite. Unless otherwise noted, 80 wt % to 100 wt % of the SiO—Si—C composite as a powder was blended with up to 20 wt % of the electroactive graphite (KS 6 synthetic graphite, Imerys S.A.). The resulting negative electrode active material was mixed thoroughly with from 1 wt % to 7 wt % single- or multi-walled carbon nanotubes as a conductive additive to form homogeneous powder mixture.

To form the negative electrode, either of two different formulations were used. One formulation included a blend of from 7 wt % to 15 wt % polyimide binder and from 1 wt % to 7 wt % lower elastic modulus binder were mixed with NMP (Sigma-Aldrich) and stirred overnight to form a polymer binder-NMP solution. The lower elastic modulus binder to polyimide binder weight ratio was 0.714. The homogenous powder mixture was then added to the polymer binder blend-NMP solution and mixed for about 2 hours to form a homogeneous slurry. The slurry was applied onto a copper foil current collector to form a thin, wet film and the laminated current collector was dried in a vacuum oven to remove NMP and to cure the polymer. The dried laminate contained from 2 to 20 wt % binder with the remainder of the electrode contributed by the powders. The other formulation included a commercial aqueous binder of a polyacrylate/polyamide constituents.

The loading level of negative electrode active material ranged from about 4.0 to about 4.8 mg/cm². The negative electrodes were electrochemically pre-lithiated with sufficient lithium (powder) to compensate for 100% to 160% of the loss of lithium due to the anode irreversible capacity loss.

To form the coin cells, a section of negative electrode was cut to size along with separator, and a section of positive electrode was also cut to size. The negative electrode capacity at the 4th cycle was balanced at 105% to 150% of the positive electrode capacity at the fourth cycle. The separator for these cells was a Celgard® porous polymer membrane. The electrodes with the separator between them was placed in a coin cell enclosure. An electrolyte selected as described below was placed in the cell and the cell was sealed.

For some examples, pouch cells having a design similar to that shown in FIG. 1A-1D were prepared as follows. The prismatic shaped pouch cells had approximate dimensions, neglecting tabs, of 145 mm×64 mm×7.7 mm (thick). The electrodes were formed as described above, and a separator sheet was pleated with electrode plated placed within the separator folds. The separator for the pouch cells was a porous polymer composite sheet with a gel-forming polymer coating. Supplemental lithium was provided by applying lithium powder (SLMP®, Livent Corp.) to the negative electrode surface prior to assembly to roughly compensate for 100% to 160% of the IRCL of the silicon based negative electrode active material. The batteries were designed to have a total capacity of roughly 11-12 Ah at a discharge rate of C/3 at 30 degrees C.

The electrolyte salts, solvents, co-solvents and additives used in the Examples are presented in Table 4.

TABLE 4

| | Salt | | | Solvent | | | | | | Co-Solvent | |
|---|---|---|---|---|---|---|---|---|---|---|---|
| Electrolyte | LiPF₆ | LiFSI | LiTFSI | DMC | EMC | DEC | FEC | FEMC | OTE | PC | MA |
| Code | (M) | (M) | (M) | (wt %) | (wt %) | (wt %) | (wt %) | (wt %) | (wt %) | (wt %) | (wt %) |
| E1 | | 1.2-1.6 | | | 70-85 | | 5-12 | | | 5-12 | |
| E2 | 0.4-0.7 | 0.8-1.2 | | 55-70 | | | 12-20 | | | 5-12 | 5-12 |
| E3 | 0.4-0.7 | 0.8-1.2 | | | 55-70 | | 12-20 | | | 5-12 | 5-12 |
| E4 | 0.1-0.4 | 0.8-1.2 | | 85 | | | 12-20 | | | | |
| E5 | 0.1-0.4 | 1.1-1.5 | | 85 | | | 12-20 | | | | |
| E6 | 0.1-0.4 | 1.2-1.6 | | 85 | | | 12-20 | | | | |
| E7 | 0.1-0.4 | 1.7-2.0 | | 85 | | | 12-20 | | | | |
| E8 | 0.1-0.4 | 2 | | 85 | | | 12-20 | | | | |
| E9 | 0.1-0.4 | 1.7-2.0 | | 55-70 | | | 12-20 | | | 5-12 | 5-12 |
| E10 | 0.1-0.4 | | 1.7-2.0 | 85 | | | 12-20 | | | | |
| E11 | 0.1-0.4 | 1.7-2.0 | | 70-80 | | | 12-20 | | | 5-12 | |
| E12 | 0.1-0.4 | | 1.7-2.0 | 55-70 | | | 12-20 | | | 5-12 | 5-12 |
| E13 | | | 1.2-1.6 | | 70-85 | | 5-12 | | | 5-12 | |
| E14 | 0.1-0.4 | 1.7-2.0 | | | | 80-88 | 12-20 | | | | |
| E15 | 0.1-0.4 | 1.7-2.0 | | | | | 12-20 | 80-88 | | | |
| E16 | 0.1-0.4 | 1.7-2.0 | | | | 10-20 | 12-20 | | 60-78 | | |
| E17 | 1.2-1.6 | | | 70-80 | | | 20-30 | | | | |
| E18 | 1.7-2.0 | | | 70-80 | | | 20-30 | | | | |
| E19 | 1.2-1.6 | | | | 70-80 | | 13.5 | | | 7-15 | |
| E20 | 0.1-0.4 | 1.7-2.0 | | 42.5 | | 40-44 | 12-20 | | | | |
| E21 | 0.1-0.4 | 1.7-2.0 | | 42.5 | | | 12-20 | 40-44 | | | |
| E22 | 0.1-0.4 | 1.7-2.0 | | 42.5 | | | 12-20 | | 30-39 | | |

### Example 1—Comparison of Lithium Salts

This example is directed to exploring the basic charging properties of cells using different lithium salts.

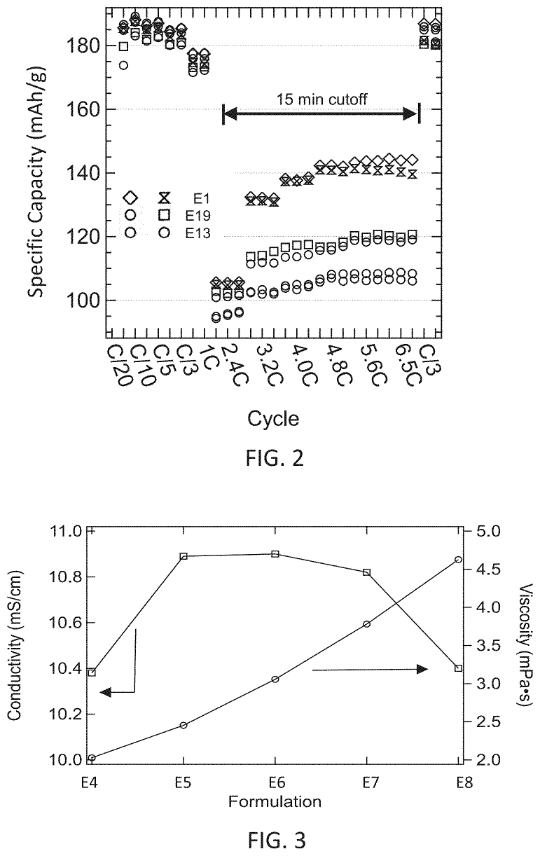

The electrode active materials were NMC622 for the positive active material and silicon oxide composite SOC for the negative active material. FIG. 2 is a plot of specific capacity as a function of cycle performed at different charge rates for coin cells prepared with electrolytes E1, E13 and E19. Each coin cell was subjected to a charge rate protocol of 28 cycles as detailed in Table 5. The charge rate protocol shows charge and discharge rates used per cycle and the number of cycles for each charge/discharge rate. Cycles 9 to 26 were performed under fast charge conditions with a cutoff of 15 minutes or upper voltage of 4.3V under different specified constant current rates. The minimum voltage limit was 2.5V.

TABLE 5

| Step | Description |
|---|---|
| A | 1 cycle for each of the following: |
| | C/20 charge + C/20 discharge |
| | C/10 charge + C/10 discharge |
| B | 2 cycles for each of the following: |
| | C/5 charge + C/5 discharge |
| | C/3 charge + C/3 discharge |
| | 1 C charge + 1 C discharge |
| C | 3 cycles for each of the following: |
| | 2.4 C (for 15 minutes) charge + 1 C discharge |
| | 3.2 C (for 15 minutes) charge + 1 C discharge |
| | 4.0 C (for 15 minutes) charge + 1 C discharge |
| | 4.8 C (for 15 minutes) charge + 1 C discharge |
| | 5.6 C (for 15 minutes) charge + 1 C discharge |
| | 6.5 C (for 15 minutes) charge + 1 C discharge |
| D | 2 cycles: |
| | C/3 charge + C/3 discharge |

The data show that cells using Electrolyte 1 comprising LiFSI exhibited greater capacities for all cycles as compared to cells using Electrolytes 13 and 19 including LiTFSI and LiPF₆, respectively, especially for the quick charge cycles, which suggest that this salt is particularly supportive of a fast charge. The data also show that despite the similarity in conductivities for LiFSI and LiPF₆, capacities of the electrolyte with LiPF₆ were lower, indicating lower charge capabilities. For all three coin cells, the final two cycles at lower charge/discharge rates indicated that no significant irreversible changes were made to the active material due to the fast charge cycles. The conductivities for E1, E13 and E19 were 8.31 mS/cm¹, 5.6 mS/cm¹ and 7.64 mS/cm¹, respectively.

### Example 2—Electrolytes With LiFSI

This example explores properties of electrolytes incorporating different concentrations of LiFSI as the lithium salt.

FIG. 3 shows combined plots of conductivity and viscosity as a function of increasing concentration of LiFSI (left to right) as indicated in Table 4 with LiPF₆ remaining constant. Viscosity increased steadily, yet conductivity peaked, held steady, and then sharply decreased beyond 1.75 M. Generally, it can be desirable to have a lower viscosity and a higher ion conductivity, but testing in cells displays more complex dimensions of these relationships.

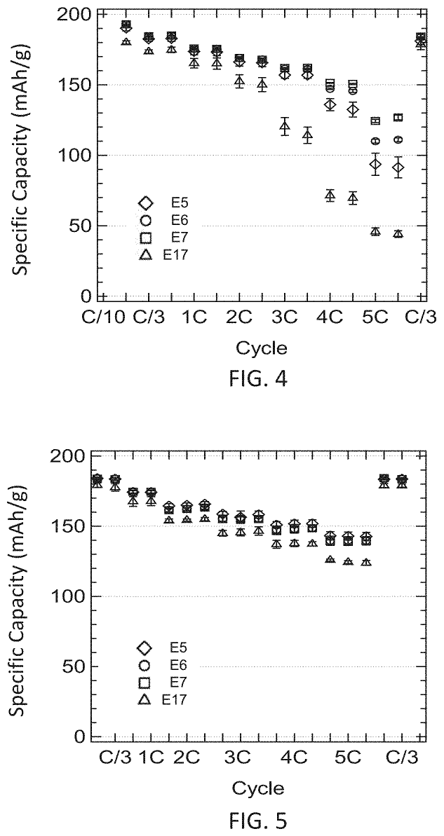

Discharge rate evaluations were carried out for coin cells assembled with electrolytes E5-E7 which corresponded to those electrolytes that gave the highest conductivities as shown in FIG. 3 along with electrolyte E17, which has only LiPF₆ lithium salt. The electrode active materials were NMC622 for the positive active material and silicon oxide composite SOC for the negative active material. FIG. 4 is a plot of capacity as a function of cycle, with corresponding charge rates, for electrolytes E5-E7 and E17. Each coin cell was subjected to a charge rate protocol as detailed in Table 6.

TABLE 6

| Step | Description |
|---|---|
| A | 1 cycle: |
| | C/10 charge + C/10 discharge |
| B | 2 cycles for each of the following: |
| | C/3 charge + C/3 discharge |
| | 1 C charge + 1 C discharge |
| | 1 C charge + 2 C discharge |
| | 1 C charge + 3 C discharge |
| | 1 C charge + 4 C discharge |
| | 1 C charge + 5 C discharge |
| C | 1 cycle: |
| | C/3 charge + C/3 discharge |

All three electrolytes E5-E7 yielded similar capacities throughout cycling up to about 1 C, but differences between them became increasing apparent after 1 C, as the discharge rate increased and capacities decreased. Electrolyte E7 exhibited the best high rate performance while electrolyte 17 comprising only LiPF₆ exhibited the worst high rate performance. All four electrolytes exhibited decreasing capacity with increasing discharge rate, but a final C/3 charge/discharge cycle indicated that no irreversible damage was inflicted on any of the four cells from the fast charge/discharge cycles.

Coin cells similarly assembled with electrolytes E5-E7 and E17 were tested using the charge rate protocol detailed in Table 7. In this study, for cycles 3-15, the charge rate increased from 1 C to 5 C and discharge remained the same at 1 C. Results are shown in FIG. 5. E5-E7 exhibited similar capacities throughout the study with electrolyte E5 exhibiting slightly better performance, and the performance of E17 was slightly worse compared to that of E5-E7. Two final C/3 charge/discharge cycles indicated that the cells did not suffer irreversible damage during the fast discharge cycles.

TABLE 7

| Step | Description |
|---|---|
| A | 2 cycles: |
| | C/3 charge + C/3 discharge |
| B | 1 cycle: |
| | 1 C charge + 1 C discharge |
| C | 3 cycles for each of the following: |
| | 2 C charge (30 min) + 1 C discharge |
| | 3 C charge (20 min) + 1 C discharge |
| | 4 C charge (15 min) + 1 C discharge |
| | 5 C charge (12 min) + 1 C discharge |
| D | 2 cycles: |
| | C/3 charge + C/3 discharge |

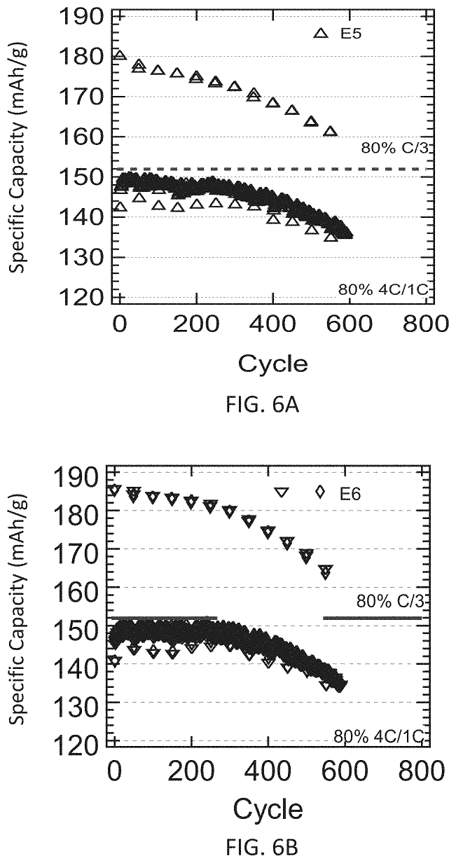

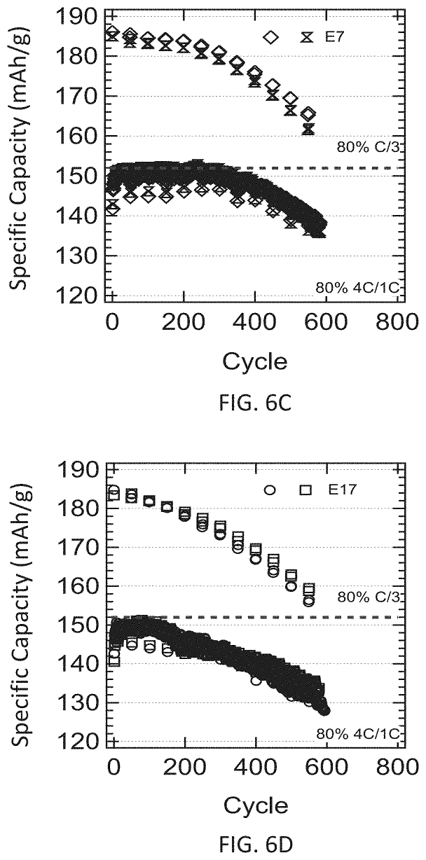

Coin cells similarly assembled with electrolytes E5-E7 and E17 were evaluated for long cycling over a voltage range of 4.3V to 2.5V. Each cell was cycled with a C/3 charge+C/3 discharge cycle (cap check), followed by 48 cycles at 4 C charge (15 minutes constant current and constant voltage)+1 C discharge. A fade check at C/3 charge discharge (cap check) was carried out every 50 cycles at C/3 charge. Capacity results as a function of cycle are shown in FIG. 6A for E5, FIG. 6B for E6, FIG. 6C for E7 and FIG. 6D for E17. Horizontal lines indicate the 80% capacity fade cutoffs at C/3 and 4 C discharge rates. Cells with all of the electrolytes exhibited good cycling performance. All four electrolytes exhibited decreasing capacity over the study, but all electrolytes were well exceeding 600 cycles with 80% fade.

### Example 3—Comparison of LiFSI/LiPF₆ Combinations

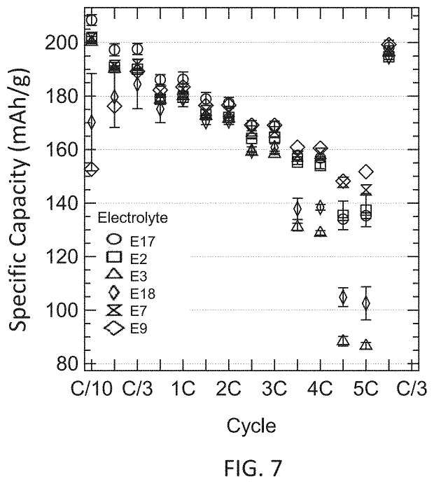

Lithium salt combinations were evaluated using a sequence of charging/discharging rates the same as described in Table 6 except without the second 5 C cycle. FIG. 7 is a plot of capacity as a function of cycle with specified charge/discharge rates coin cells assembled with electrolytes E2, E3, E7, E9, E17 and E18. The electrode active materials were NMC811 for the positive active material and silicon oxide composite SOC for the negative active material. Each coin cell was subjected to a charge rate protocol as detailed in Table 6 with a voltage range of 4.2V to 2.5V. Differences between the electrolytes became increasingly apparent after 1 C, as the discharge rate increased and capacities decreased. Electrolytes E7 and E9 had the highest concentrations of LiFSI and exhibited the best high rate performance, while E17 and E18 comprising only LiPF₆ exhibited the worst high rate performance. All six electrolytes exhibited decreasing capacity with increasing discharge rate, but a final C 3 charge/discharge cycle confirmed that the cells had not exhibited any significant irreversible capacity loss over the cycles examined.

### Example 4—Comparison of Solvent Combinations

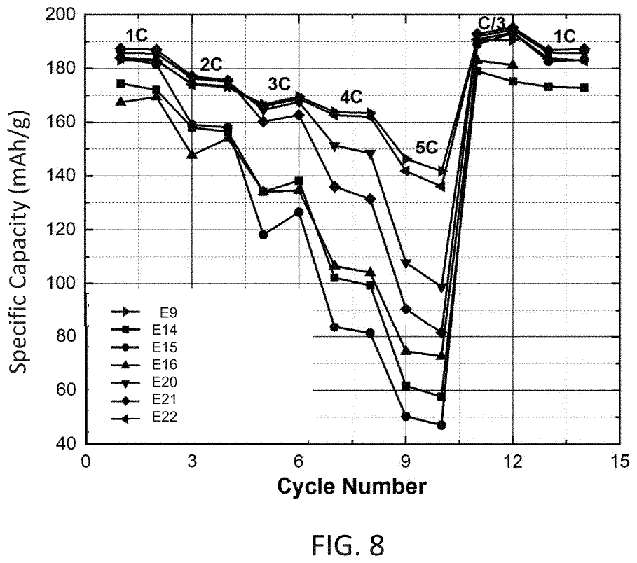

Various solvent combinations were evaluated using a sequence of charging/discharging rates detailed in Table 8 which is similar to that of Table 6. FIG. 8 is a plot showing specific capacity as a function of cycle number for coin cells assembled with electrolytes E9, E14-E16 and E20-E22. Comparison of the specific capacities for electrolytes E14-E16 indicates DEC provided better performance as compared to FEMC, and OTE was better than both DEC and FEMC. Electrolytes E20-E22 resulted in improved performance relative to similar electrolytes E14-E16, particularly for E16 including OTE. Electrolytes E9 (including additives PC and MA) and E22 (including OTE) exhibited better performance compared to all the others. All the electrolytes exhibited decreasing capacity over the study. Capacities obtained during the final C/3 and 1 C charge/discharge steps indicated no significant irreversible capacity changes.

TABLE 8

| Step | Description |
|---|---|
| A | 2 cycles for each of the following: |
| | 1 C charge + 1 C discharge |
| | 1 C charge + 2 C discharge |
| | 1 C charge + 3 C discharge |
| | 1 C charge + 4 C discharge |
| | 1 C charge + 5 C discharge |
| B | 1 cycle: |
| | C/3 charge + C/3 discharge |
| C | 2 cycles: |
| | 1 C charge + 1 C discharge |

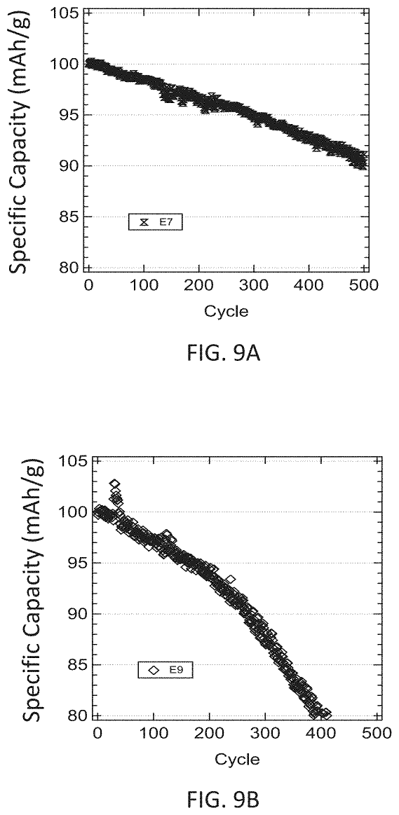

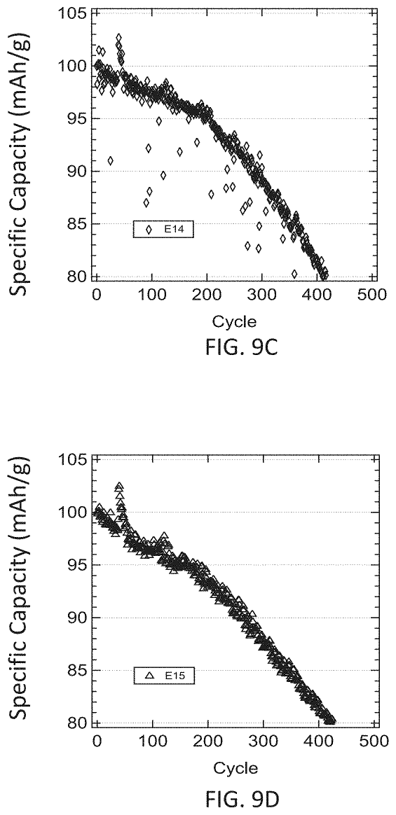

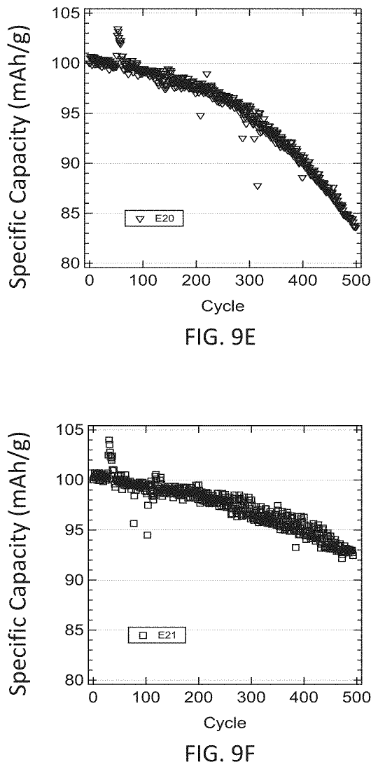

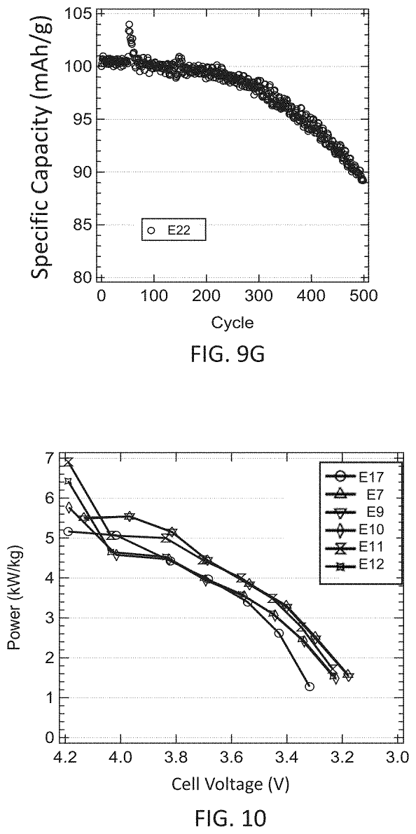

FIGS. 9A-9G are plots of normalized capacity as a function of cycle number for coin cells assembled with electrolytes E7, E9, E14, E15, E20, E21 and E22, respectively. In this study, charging and discharging were performed at a rate of 1 C over a voltage range of 4.2V to 2.5V, and long cycling performance was examined. Comparison of the normalized capacities showed that electrolytes E20-E22 performed better than E9, E14 and E15 which were similar to each other. E7, E21 and E22 performed better than E9.

### Example 5—Large Format Pouch Cells

Electrolytes were evaluated in large format pouch cells assembled as described above and designed to have a total capacity of roughly 11-12 Ah at a discharge rate of C/3 at 30 degrees C. The studies were carried out over a voltage window from 4.2V to 2.5V.

FIG. 10 shows a plot of power as a function of cell voltage for electrolytes E7, E9-E12 and E17. The pouch cells were charged to 4.2V with a constant current and constant voltage charge. Power and resistance were measured with a 5 C, 30 second discharge pulse for every 10% state of charge (SOC). Following each discharge pulse, the cell was discharged at a C/3 rate to the next SOC level based on the cell voltage. Superior performance was obtained for electrolytes E7, E9 and E11 including LiFSI and LiPF₆, as compared to electrolytes E10 and E12 including LiTFSI and LiPF₆. Electrolyte E11 also exhibited good power output behavior. Overall, E7 and E9 exhibited superior power performance over other electrolyte formulations.

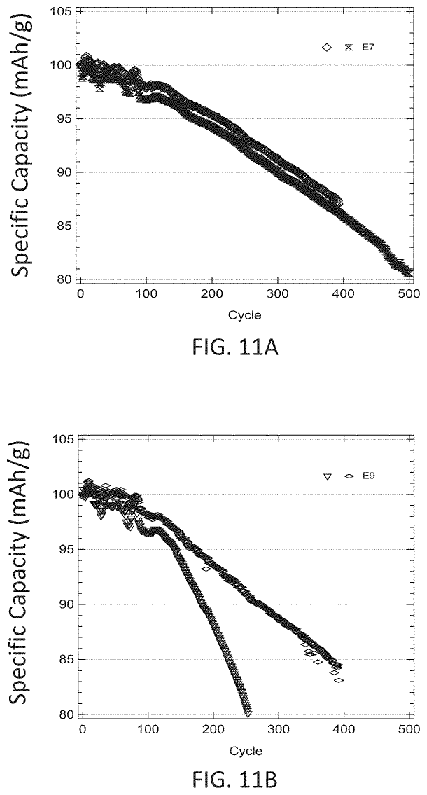

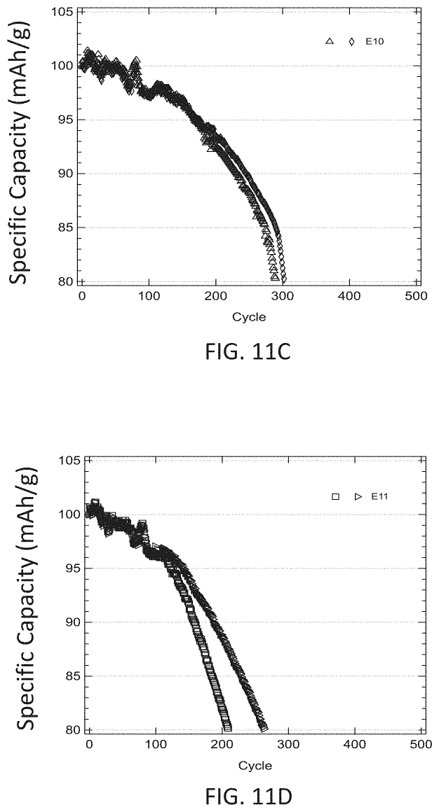

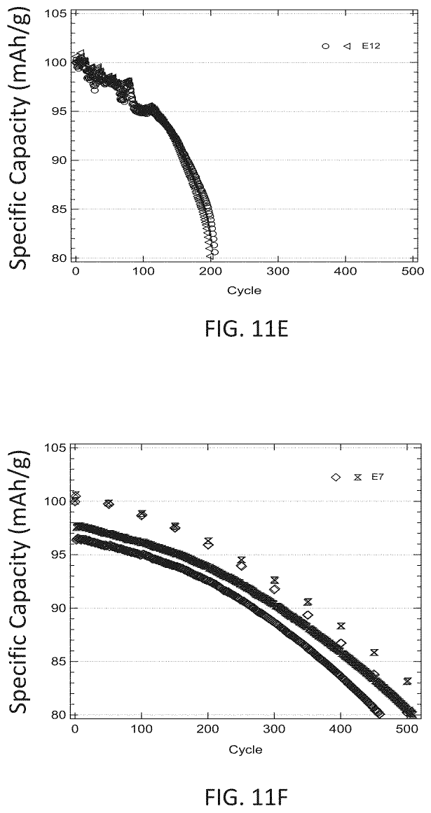

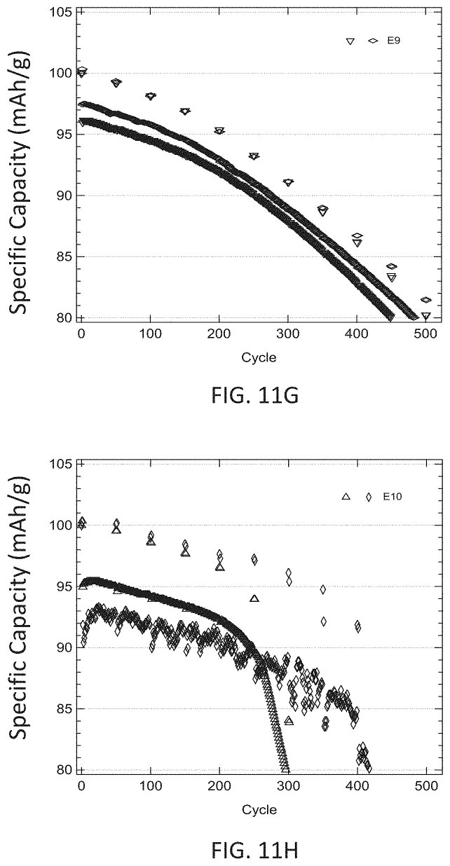

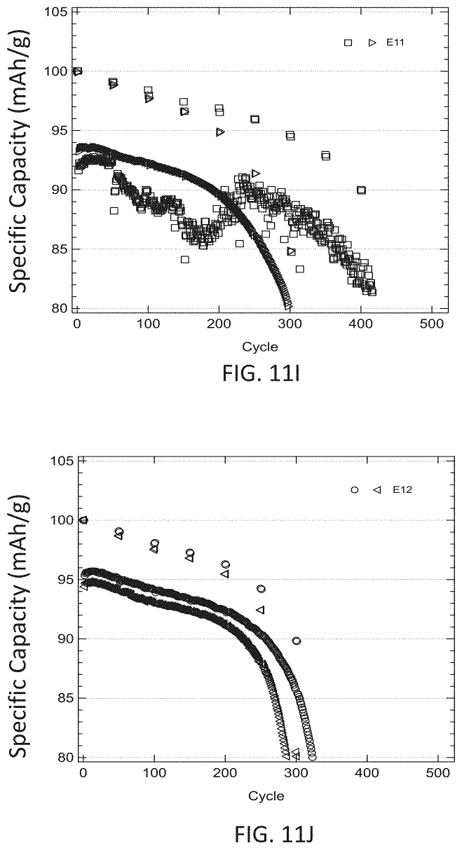

Plots of normalized capacity (normalized to C/3 capacity) showing long cycling performance for electrolytes E7 and E9-E12 in large format pouch cells are shown in FIGS. 11A-11J. Data shown in FIGS. 11A-11E, for cells prepared with E7, E9, E10, E11 and E12, respectively, were obtained by cycling the cells at 1 C charging and discharging. Data shown in FIGS. 11F-11J, for cells prepared with E7, E9, E10, E11 and E12, respectively, were obtained by cycling the cells at 3 C charging and 1 C discharging with C/3 cap check every 48 cycles. The 3 C charge was performed with a 20 minute 3 C charge step followed by a 10 minute constant voltage charge for an overall 30 minute charge process. Particularly good cycling performance was found for E7 and E9, although reasonable cycling performance was found for all of the cells tested. Electrolyte E7 performs about the same as E9 under 3 C/1 C conditions.

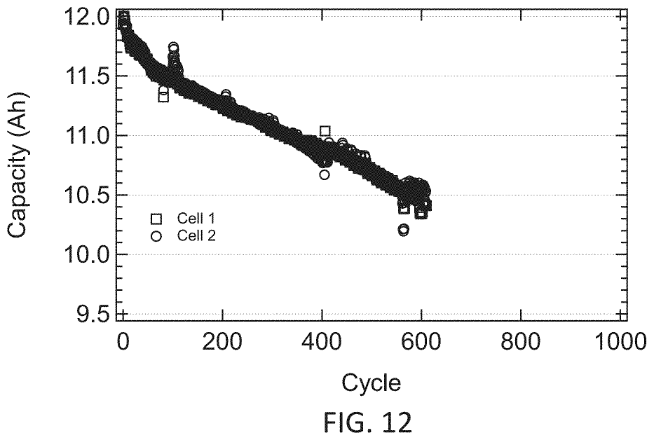

FIG. 12 is a plot showing capacity as a function of cycle for two large format pouch cells at 30° C. Electrolyte 9 was used in both Cell 1 and Cell 2, and the cells were subjected to 1 C charging/discharging cycling. These cells were easily exceeding 600 cycles with greater than 90% capacity retention.

### Example 6—Coin Cell Cycling

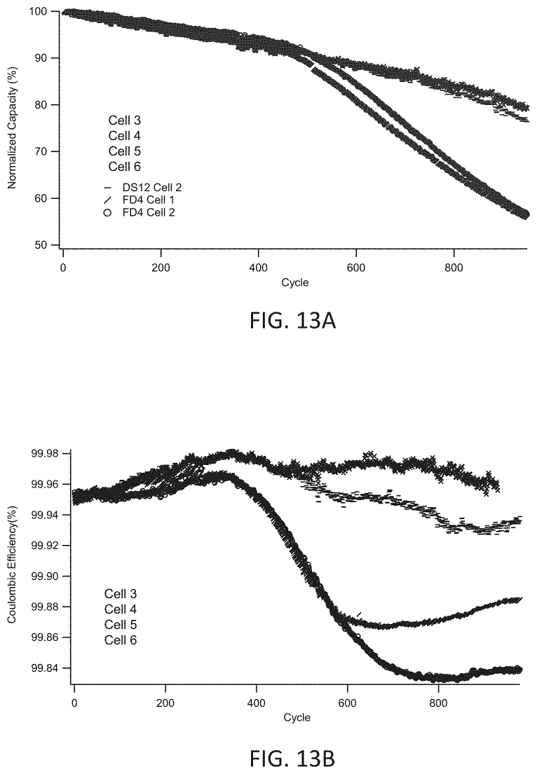

Electrolytes were evaluated in coin cells assembled as described above. Electrolyte E7 was used in Cell 3 and Cell 4, and E17 was used in Cell 5 and Cell 6. The cells were subjected to 1 C charging/discharging cycling. Normalized capacity as a percent as a function of cycle are shown in FIG. 13A. Coulombic efficiency ((discharge capacity/charge capacity)×100%) as a function of cycle are shown in FIG. 13B.

### Example 7—Large Format Pouch Cells

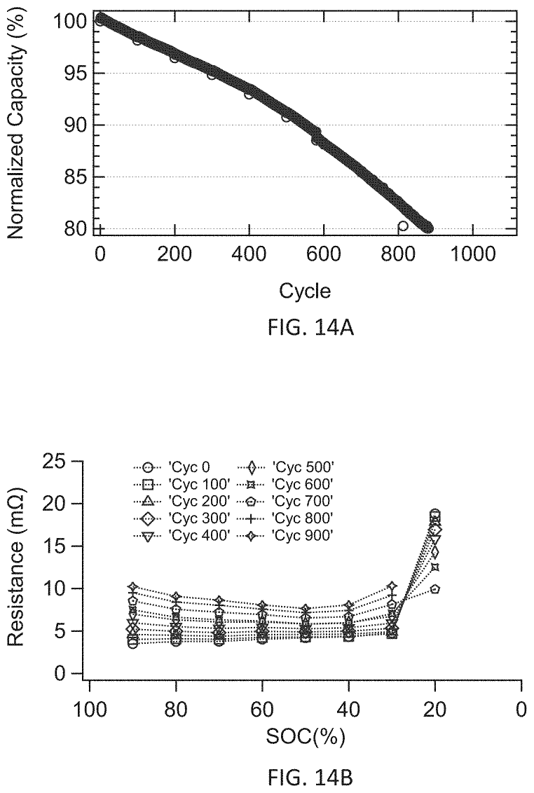

Electrolyte E7 was evaluated in large format pouch cells assembled as described above and designed to have a total capacity of roughly 32 Ah at a discharge rate of C/3 at 30 degrees C. The studies were carried out over a voltage window from 4.2V to 2.5V. FIG. 14A is a plot of normalized capacity as a function of cycle number for the cell cycled with a 1 C charge/1 C discharge rate. The electrode active materials were NMC811 for the positive active material and silicon oxide composite (SOC) for the negative active material. Resistance was monitored to verify low growth to end of life, such that the resistance at 50% state-of-charge did not surpass 2.5 times the resistance at cycle 0. FIG. 14B is a plot of resistance as a function of percent SOC at different cycles, ranging from 0 cycles to 900 cycles. The pouch cell was cycled with a 1 C charge/1 C discharge rate with a 1 C hybrid pulse power characterization (HPPC) pulse (30 seconds) taken every 100 cycles.

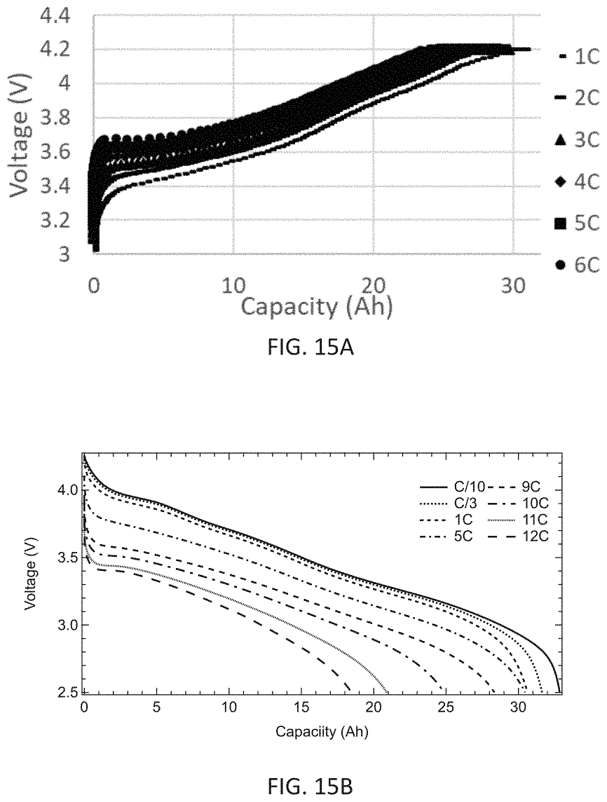

FIG. 15A is a plot of voltage as a function of capacity for the large format pouch cell prepared with electrolyte E7 during charging at rates from C to 6 C. The cells are charged at constant rate until the charge voltage of 4.2V is reached, and then the cells are charged at constant voltage until the current drops below a threshold or the cell reached the max time. The charge rate protocol is detailed in Table 9. The final capacity of the 1 C charged cell was slightly higher, and the charge capacity of the cells charged from 2 C to 6 C were approximately the same.

TABLE 9

| Step | Description |
|---|---|
| A | 1 cycle for each of the following: |
| | 1 C charge (60 min) + C/3 discharge |
| | 2 C charge (30 min) + C/3 discharge |
| | 3 C charge (20 min) + C/3 discharge |
| | 4 C charge (15 min) + C/3 discharge |
| | 5 C charge (12 min) + C/3 discharge |
| | 6 C charge (10 min) + C/3 discharge |

FIG. 15B is a plot of voltage as a function of capacity for the pouch cell described for FIG. 15A during discharge at different rates from C/10 to 12 C. The cells were charged at C/3 and discharged at rates from C/10 to 12 C. A discharge capacity over 18 Ah was exhibited even at 12 C, which is very high rate capability.

### Additional Inventive Concepts

1. A lithium ion cell comprising:

a negative electrode comprising from about 75 wt % to about 96 wt % an active material, from about 0.1 wt % to about 7 wt % nanoscale conductive particulates and from about 4 wt % to about 20 wt % polymer binder, wherein the active material comprises from about 45 wt % to about 100% silicon-based active material, and from 0 wt % to about 55 wt % graphitic carbon;

a positive electrode comprising a lithium metal oxide, conductive particulates, and a polymer binder;

a separator between the negative electrode and the positive electrode;

electrolyte comprising from about 1.1M to about 2.2M lithium salt and non-aqueous solvent, wherein the lithium salt comprises from about 60 mole percent to about 100 mole percent LiFSI, LiTFSI, or a mixture thereof, and wherein the non-aqueous solvent comprises from about 5 wt % to about 25 wt % fluoroethylene carbonate, 35 wt % to 90 wt % dimethyl carbonate, and from 0 to about 50 wt % diethyl carbonate, hydrofluoroether, fluoroalkyl carbonate, propylene carbonate, ethyl acetate, methyl acetate, propyl acetate, or mixtures thereof, wherein the weight percent values are relative to the solvent;

a container enclosing the negative electrode, the positive electrode, the separator and the electrolyte;

wherein the cell has a discharge specific capacity at a rate of 4 C of at least about 120 mAh/g between 2.5V and a selected charge voltage based on the weight of the cathode active material and wherein the impedance is no more than about 10 mOhms at the 600th cycle at a state of charge of 30%.

2. The lithium ion cell of concept 1 wherein the silicon-based active material comprises a silicon-silicon oxide carbon composite material.
3. The lithium ion cell of concept 1 wherein the graphitic carbon has a BET surface area from about 1 m²/g to about 20 m²/g.
4. The lithium ion cell of concept 1 wherein the polymer binder of the negative electrode comprises a blend of at least about 50 wt % polyimide and a second polymer binder selected from the group consisting of polyvinylidene fluoride, cellulose, styrene-butadiene rubber, lithiated polyacrylic acid, copolymers thereof and mixtures thereof, wherein the polyimide has an elongation of at least about 40% and the second polymer binder has an elasticity greater than that of the polyimide.
5. The lithium ion cell of concept 1 wherein the polymer binder of the negative electrode comprises a water soluble binder.
6. The lithium ion cell of concept 5 wherein the water soluble binder comprises poly (acrylamide-co-acrylate salt) having at least about 5 mole percent of the acrylate salt moiety and at least about 5 mole percent of the acrylamide moiety.
7. The lithium ion cell of concept 5 wherein the water soluble binder comprises metal-poly acrylic acid/acrylate (M-PAA) moieties form corresponding monomers, where M is a cation of lithium, sodium, potassium or a mixture thereof.
8. The lithium ion cell of concept 1 wherein the lithium metal oxide comprises a lithium nickel cobalt manganese oxide approximately represented by the formula LiNiₓMn_{y}Co_{z}O₂, where 0.45≤x, 0.05≤y, z≤0.35, x+y+z≈1.
9. The lithium ion cell of concept 1 further comprising supplemental lithium in an amount from about 80% to about 180% of the negative electrode first cycle irreversible capacity loss, the lithium ion cell having a ratio at the fourth cycle at a discharge rate of C/3 of negative electrode capacity divided by the positive electrode capacity from about 1.10 to about 1.95.
10. The lithium ion cell of concept 1 wherein the lithium salt comprises from about 0.05M to about 0.8M LiPF₆, and wherein the solvent comprises from about 65 wt % to about 95 wt % cosolvent consisting of at least about 30 wt % dimethyl carbonate, from 0 to about 50 wt % diethyl carbonate, from 0 to about 50 wt % hydrofluoro ether, from about 0 to about 50 wt % fluorinated linear carbonate, from about 0 to about 20 wt % propylene carbonate, from about 0 to about 20 wt % alkyl acetate, and mixtures thereof, wherein the weight percent values of fluoroethylene carbonate and cosolvent add to 100 wt %.
11. The lithium ion cell of concept 1 wherein the lithium salt comprises from about 0.05M to about 0.4M LiPF₆, and wherein the solvent comprises from about 5 wt % to about 20 wt % fluoroethylene carbonate and cosolvent consisting essentially of from about 35 wt % to about 70 wt % dimethyl carbonate, from 0 to about 50 wt % hydrofluoro ether, from about 0 to about 50 wt % fluorinated linear carbonate, from about 0 to about 20 wt % propylene carbonate, from about 0 to about 20 wt % alkyl acetate, and mixtures thereof, wherein the combined weight percent of hydrofluoroether, fluoronated linear carbonate, propylene carbonate and alkyl acetate is at least about 10 wt %.
12. The lithium ion cell of concept 1 wherein the negative electrode active material comprises from about 60 wt % to about 95 wt % silicon-oxide based material and from about 5 wt % to about 40 wt % graphite.
13. The lithium ion cell of concept 1 wherein the lithium ion cell has a capacity at the 600th cycle of at least about 80% of the capacity at the 7th cycle when cycled at room temperature from the 10th cycle to the 600th cycle between 2.5V and the selected charge voltage at a rate of 4 C.
14. The lithium ion cell of concept 1 wherein the impedance is no more than about 10 mOhms at the 600th cycle at a state of charge of 30% and wherein the cell exhibits a power of at least 2 kW/kg for a 30 second discharge at 5 C at a 30% state of charge.
15. A lithium ion cell comprising:

a negative electrode comprising from about 75 wt % to about 96 wt % an active material from about 0.1 wt % to about 7 wt % nanoscale conductive carbon and from about 4 wt % to about 20 wt % polymer binder, wherein the active material comprises from about 45 wt % to about 100% silicon-based active material, and from 0 to about 55 wt % graphitic carbon;

a positive electrode comprising a lithium metal oxide, conductive carbon, and a polymer binder;

a separator between the negative electrode and the positive electrode;

electrolyte comprising from about 1.1M to about 2.2M lithium salt and non-aqueous solvent, wherein the lithium salt comprises from about 60 mole percent to about 100 mole percent LiFSI, LiTFSI, or a mixture thereof, and wherein the non-aqueous solvent comprises from about 5 wt % to about 25 wt % fluoroethylene carbonate, 35 wt % to 90 wt % dimethyl carbonate, and from 0 to about 50 wt % diethyl carbonate, hydrofluoroether, fluoroalkyl carbonate, propylene carbonate, ethyl acetate, methyl acetate, propyl acetate, or mixtures thereof, wherein the weight percent values are relative to the solvent; and

a container enclosing the negative electrode, the positive electrode, the separator and the electrolyte;

wherein the cell has a discharge capacity at a 5 C discharge to 2.5V from a specified charge voltage of at least about 90 mAh/g based on the weight of the cathode active material and a pulse power density at a rate of 5 C for a pulse of 30 second at a state of charge of 30% of at least about 2.0 kW/kg.

16. The lithium ion cell of concept 15 wherein the silicon-based active material comprises a silicon-silicon oxide carbon composite material.
17. The lithium ion cell of concept 15 wherein the graphitic carbon has a BET surface area from about 1 m²/g to about 20 m²/g.
18. The lithium ion cell of concept 15 wherein the polymer binder of the negative electrode comprises a blend of at least about 50 wt % polyimide and a second polymer binder selected from the group consisting of polyvinylidene fluoride, cellulose, styrene-butadiene rubber, lithiated polyacrylic acid, copolymers thereof and mixtures thereof, wherein the polyimide has an elongation of at least about 40% and the second polymer binder has an elasticity greater than that of the polyimide.
19. The lithium ion cell of concept 15 wherein the polymer binder of the negative electrode comprises a water soluble binder.
20. The lithium ion cell of concept 19 wherein the water soluble binder comprises poly (acrylamide-co-acrylate salt) having at least about 5 mole percent of the acrylate salt moiety and at least about 5 mole percent of the acrylamide moiety.
21. The lithium ion cell of concept 19 wherein the water soluble binder comprises metal-poly acrylic acid/acrylate (M-PAA) moieties form corresponding monomers, where M is a cation of lithium, sodium, potassium or a mixture thereof.
22. The lithium ion cell of concept 15 wherein the lithium metal oxide comprises a lithium nickel cobalt manganese oxide approximately represented by the formula LiNiₓMn_{y}Co_{z}O₂, where 0.45≤x, 0.05≤y, z≤0.35, x+y+z≈1.
23. The lithium ion cell of concept 15 further comprising supplemental lithium in an amount from about 80% to about 180% of the negative electrode first cycle irreversible capacity loss, the lithium ion cell having a ratio at the fourth cycle at a discharge rate of C/3 of negative electrode capacity divided by the positive electrode capacity from about 1.10 to about 1.95.
24. The lithium ion cell of concept 15 wherein the lithium salt comprises from about 0.05M to about 0.8M LiPF₆, and wherein the solvent comprises from about 65 wt % to about 95 wt % cosolvent consisting of at least about 30 wt % dimethyl carbonate, from 0 to about 50 wt % diethyl carbonate, from 0 to about 50 wt % hydrofluoro ether, from about 0 to about 50 wt % fluorinated linear carbonate, from about 0 to about 20 wt % propylene carbonate, from about 0 to about 20 wt % alkyl acetate, and mixtures thereof, wherein the weight percent values of fluoroethylene carbonate and cosolvent add to 100 wt %.
25. The lithium ion cell of concept 15 wherein the lithium salt comprises from about 0.05M to about 0.4M LiPF₆, and wherein the solvent comprises from about 5 wt % to about 20 wt % fluoroethylene carbonate and cosolvent consisting essentially of from about 35 wt % to about 70 wt % dimethyl carbonate, from 0 to about 50 wt % hydrofluoro ether, from about 0 to about 50 wt % fluorinated linear carbonate, from about 0 to about 20 wt % propylene carbonate, from about 0 to about 20 wt % alkyl acetate, and mixtures thereof, wherein the combined weight percent of hydrofluoroether, fluoronated linear carbonate, propylene carbonate and alkyl acetate is at least about 10 wt %.
26. The lithium ion cell of concept 15 wherein the negative electrode active material comprises from about 60 wt % to about 95 wt % silicon-oxide based material and from about 5 wt % to about 40 wt % graphite.
27. The lithium ion cell of concept 15 wherein the lithium ion cell has a capacity at the 600th cycle of at least about 80% of the capacity at the 7th cycle when cycled at room temperature from the 10th cycle to the 600th cycle between 2.5V and the selected charge voltage at a rate of 4 C.
28. The lithium ion cell of claim 15 wherein has a discharge specific capacity at a rate of 4 C of at least about 120 mAh/g between 2.5V and a selected charge voltage based on the weight of the cathode active material and wherein the impedance is no more than about 10 mOhms at the 600th cycle at a state of charge of 30%.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understand that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated.

What is claimed is:

1. A high rate capable electrolyte for a lithium-based cell consisting of:
about 1.3M to about 2.5M lithium salt, consisting of from about 0.05M to about 0.8M LiPF₆, from about 0.8M to about 2.1M lithium bis(fluorosulfonyl)imide (LiFSI) or lithium bis(trifluoromethanesulfonyl)imide (LiTFSI), and no more than about 5 mole percent optional other lithium salts;
from about 5 weight percent (wt %) to about 25 wt % fluoroethylene carbonate;
from about 65 wt % to about 95 wt % cosolvent consisting of at least about 30 wt % dimethyl carbonate, from 0 to about 50 wt % diethyl carbonate, from 0 to about 50 wt % hydrofluoro ether, from about 0 to about 50 wt % fluorinated linear carbonate, from about 0 to about 20 wt % propylene carbonate, from about 0 to about 20 wt % alkyl acetate, and mixtures thereof, wherein the weight percent values of fluoroethylene carbonate and cosolvent add to 100 wt %; and
no more than about 10 weight percent optional additives relative to the total electrolyte weight.

2. The high rate capable electrolyte of claim 1
wherein the lithium salt consists essentially of about 0.1M to about 0.4M LiPF₆ and LiFSI.

3. The high rate capable electrolyte of claim 1
wherein the solvent consists essentially of from about 5 wt % to about 25 wt % fluoroethylene carbonate; and
from about 75 wt % to about 95 wt % dimethyl carbonate.

4. The high rate capable electrolyte of claim 1
wherein the cosolvent consists essentially of dimethyl carbonate, propylene carbonate and an alkyl acetate.

5. The high rate capable electrolyte of claim 1
wherein the cosolvent consists essentially of dimethyl carbonate and linear fluorocarbonate.

6. The electrolyte of claim 5
wherein the linear fluorocarbonate comprises fluoroethylmethylcarbonate.

7. The electrolyte of claim 5
wherein the linear fluorocarbonate is CF₃CH₂O(CO)OCH₃

8. The electrolyte of claim 7 wherein the weight ratio of dimethyl carbonate to CF₃CH₂O(CO)OCH₃ is from about 1:0.6 to about 1:1.2.

9. The electrolyte of claim 1
wherein the cosolvent consists essentially of dimethyl carbonate and a hydrofluoro ether.

10. The electrolyte of claim 9
wherein the hydrofluoro ether comprises CHF₂(CF₂)₃CH₂OCF₂CHF₂.

11. The electrolyte of claim 10 wherein the weight ratio of dimethyl carbonate to CHF₂(CF₂)₃CH₂OCF₂CHF₂ is from about 1:0.6 to about 1:1.2.

12. The electrolyte of claim 1 wherein the optional additives are selected from the group consisting of triethyl phosphate (TEP), ethoxy(pentafluoro)cyclotriphosphazene (PFPN), 1,3-propane sultone (PS), and mixtures thereof.

13. The electrolyte of claim 12 comprising from about 0.1 wt % to about 5 wt % additive.

14. The electrolyte of claim 1 wherein the optional lithium salt additive is LiBF₄, LiBOB, LiBFP, LiDFOB, or mixtures thereof.

15. The electrolyte of claim 14 wherein the lithium salt comprises from about 0.1 mole percent to about 2.5 mole percent lithium salt additive.

16. The electrolyte of claim 1 having from about 0.05M to about 0.4M LiPF₆ and from about 1.5M to about 2.1M lithium bis(fluorosulfonyl)imide (LiFSI), and cosolvent consisting of from about 35 wt % to about 70 wt % dimethyl carbonate, from 0 to about 50 wt % hydrofluoro ether, from about 0 to about 50 wt % fluorinated linear carbonate, from about 0 to about 20 wt % propylene carbonate, from about 0 to about 20 wt % alkyl acetate, and mixtures thereof, wherein the combined weight percent of hydrofluoroether, fluoronated linear carbonate, propylene carbonate and alkyl acetate is at least about 10 wt %.

17. A lithium ion cell comprising:
a negative electrode comprising from about 75 wt % to about 96 wt % an active material, from about 0.1 wt % to about 7 wt % nanoscale conductive particulates and from about 4 wt % to about 20 wt % polymer binder, wherein the active material comprises from about 45 wt % to about 100% silicon-based active material, and from 0 wt % to about 55 wt % graphitic carbon;
a positive electrode comprising a lithium metal oxide, conductive particulates, and a polymer binder;
a separator between the negative electrode and the positive electrode;
electrolyte comprising from about 1.1M to about 2.2M lithium salt and non-aqueous solvent, wherein the lithium salt comprises from about 60 mole percent to about 100 mole percent LiFSI, LiTFSI, or a mixture thereof, and wherein the non-aqueous solvent comprises from about 5 wt % to about 25 wt % fluoroethylene carbonate, 35 wt % to 90 wt % dimethyl carbonate, and from 0 to about 50 wt % diethyl carbonate, hydrofluoroether, fluoroalkyl carbonate, propylene carbonate, ethyl acetate, methyl acetate, propyl acetate, or mixtures thereof, wherein the weight percent values are relative to the solvent;
a container enclosing the negative electrode, the positive electrode, the separator and the electrolyte;
wherein the cell has a discharge specific capacity at a rate of 4 C of at least about 120 mAh/g between 2.5V and a selected charge voltage based on the weight of the cathode active material and wherein the impedance is no more than about 10 mOhms at the 600th cycle at a state of charge of 30%.

18. The lithium ion cell of claim 17 wherein the silicon-based active material comprises a silicon-silicon oxide carbon composite material.

19. The lithium ion cell of claim 17 wherein the graphitic carbon has a BET surface area from about 1 m²/g to about 20 m²/g.
